(19) United States
(12) Patent Application Publication
(10) Pub. No.: US 2025/0330749 A1
(43) Pub. Date: Oct. 23, 2025

(54) ACOUSTIC CONTROL DEVICE AND ACOUSTIC CONTROL PROGRAM

(71) Applicant: AlphaTheta Corporation, Yokohama-shi, Kanagawa (JP)

(72) Inventors: Kenta Sagawa, Yokohama-shi, Kanagawa (JP); Nao Takagi, Yokohama-shi, Kanagawa (JP); Takashi Mashita, Yokohama-shi, Kanagawa (JP)

(21) Appl. No.: 18/871,003

(22) PCT Filed: Jul. 22, 2022
(86) PCT No.: PCT/JP2022/028519

§ 371 Date: Dec. 2, 2024

(51) Int. Cl. H04R 3/04; G06F 3/0362

(52) U.S. Cl. CPC H04R 3/04; G06F 3/0362; H04R 2420/01; H04R 2430/01; H04R 2430/03

(57) ABSTRACT

An acoustic control device for mixing a first music piece and a second music piece is configured to switch a magnitude relationship between a volume of the first music piece in a low-frequency band and a volume of the second music piece in a low-frequency band by lowering the volume level of the first music piece in the low-frequency band and raising the volume level of the second music piece in the low-frequency band in accordance with an operation of an operator for controlling the volume of the first music piece and the volume of the second music piece.

### TECHNICAL FIELD

The present invention relates to an acoustic control device and an acoustic control program.

### BACKGROUND ART

Some of typically known acoustic devices are configured to mix and output a plurality of music pieces (see, for instance, Patent Literature 1).

The acoustic device disclosed in Patent Literature 1, which is a so-called mixer, is configured to mix music pieces provided through a music supply device (e.g. a PC and a smartphone) and output audio signals corresponding to the mixed music pieces to a speaker.

The acoustic device includes operators such as a first channel fader, a second channel fader, and a cross fader. Each of the first channel fader and the second channel fader includes vertically movable operator(s) and the cross fader includes a horizontally movable operator. The acoustic device is configured to adjust, in response to an operation of the first channel fader, a volume of a music piece that have been inputted to a first channel from the music supply device, and is configured to adjust, in response to an operation of the second channel fader, a volume of a music piece that have been inputted to a second channel from the music supply device. In addition, the acoustic device is configured to adjust a balance between the volume of the first channel and the volume of the second channel in response to an operation of the cross fader. For instance, a ratio of the volume of the first channel in the volume outputted by the acoustic device increases as the operator of the cross fader is moved leftward, and a ratio of the volume of the second channel in the volume outputted by the acoustic device increases as the operator of the cross fader is moved rightward.

### CITATION LIST

### Patent Literature(S)

Patent Literature 1: International Publication No. 2022/054263

### SUMMARY OF THE INVENTION

### Problem(s) to be Solved by the Invention

However, it is difficult for an unaccustomed user (e.g. a beginner) to operate the acoustic device to mix the music piece inputted to the first channel and the music piece inputted to the second channel without arousing uncomfortable impression.

### Means for Solving the Problem(s)

According to a first aspect of the invention, an acoustic control device is configured to mix a first music piece and a second music piece, in which a magnitude relationship between a volume of the first music piece in a low-frequency band and a volume of the second music piece in a low-frequency band is switched by lowering a volume level of the first music piece in the low-frequency band and raising a volume level of the second music piece in the low-frequency band.

According to a second aspect of the invention, an acoustic control program is recorded in a manner readable by a computer, the acoustic control program causing the computer to function as the acoustic control device according to the first aspect.

### BRIEF EXPLANATION OF DRAWING(S)

FIG. 1 schematically illustrates a configuration of an acoustic device according to a first exemplary embodiment.

FIG. 2 schematically illustrates a high-frequency band adjuster, a medium-frequency band adjuster, and a low-frequency band adjuster of the first exemplary embodiment.

FIG. 3 is a block diagram illustrating a controller of the first exemplary embodiment.

FIG. 4 illustrates a change in volume of an entire first music piece and a change in volume of an entire second music piece when a cross fader is operated in a normal mode in the first exemplary embodiment.

FIG. 5 illustrates a change in volume level of each of frequency bands of the first music piece and a change in volume level of each of frequency bands of the second music piece when the cross fader is operated in the normal mode of the first exemplary embodiment.

FIG. 6 illustrates a change in volume level of each of the frequency bands of the first music piece and a change in volume level of each of the frequency bands of the second music piece when the cross fader is operated in an assist mode of the first exemplary embodiment.

FIG. 7 illustrates a change in volume level of the first music piece in each frequency band and a change in volume level of the second music piece in each frequency band when a preset level of the first music piece in a low-frequency band is 0.6 in the first exemplary embodiment.

FIG. 8 illustrates a change in volume of the entire first music piece when a first channel fader is operated and a change in volume of the entire second music piece when a second channel fader is operated, in the normal mode in the first exemplary embodiment.

FIG. 9 illustrates a change in volume level of the first music piece in a high-frequency band and a medium-frequency band and a change in volume level of the second music piece in a high-frequency band and a medium-frequency band, when the respective channel faders are operated in the assist mode of the first exemplary embodiment.

FIG. 10 illustrates an example of a change in volume level of the first music piece in the low-frequency band and a change in volume level of the second music piece in the low-frequency band, when the respective channel faders are operated in the assist mode of the first exemplary embodiment.

FIG. 11 is a block diagram illustrating a controller of an acoustic control device according to a second exemplary embodiment.

FIG. 12 illustrates an example of a change in playback BPM of each of the first and second music pieces in an assist mode of the second exemplary embodiment.

FIG. 13 illustrates another example of a change in playback BPM of each of the first and second music pieces in the assist mode of the second exemplary embodiment.

FIG. 14 illustrates still another example of a change in playback BPM of each of the first and second music pieces in the assist mode of the second exemplary embodiment.

FIG. 15 illustrates an example of a first playback control process by a playback control unit in the second exemplary embodiment.

### DESCRIPTION OF EMBODIMENT(S)

### First Exemplary Embodiment

A first exemplary embodiment of the invention will be described below with reference to the attached drawings.

### Configuration of Acoustic Control Device

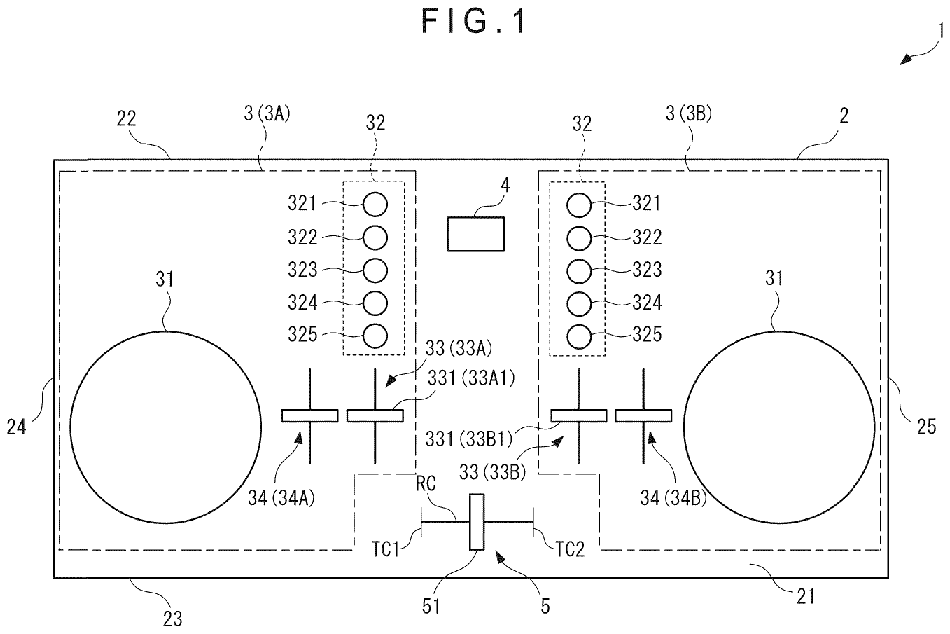

FIG. 1 schematically illustrates a configuration of an acoustic control device 1 according to the exemplary embodiment.

The acoustic control device 1 according to the exemplary embodiment mixes a plurality of music pieces. Specifically, the acoustic control device 1 mixes a first music piece loaded to a first channel and a second music piece loaded to a second channel and outputs audio signals corresponding to the mixed music pieces.

As detailed later, one of features of the acoustic control device 1 is that the acoustic control device 1 has a normal mode for mixing the first and second music pieces in accordance with operations on a plurality of operators and an assist mode for assisting the mixing operation of the first and second music pieces.

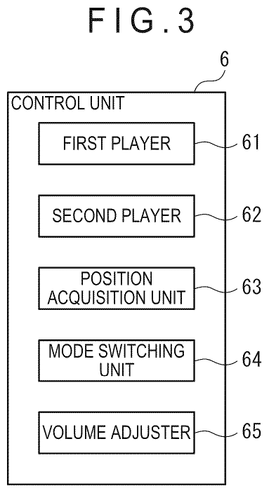

As illustrated in FIG. 1, the acoustic control device 1 includes a casing 2, two channel operation units 3, a mode changeover switch 4, and a cross fader 5. Though not illustrated in FIG. 1, the acoustic control device 1 further includes a controller 6 (see FIG. 3) for controlling the operation of the acoustic control device 1.

### Configuration of Casing

The casing 2 has a substantially rectangular parallelepiped shape and houses the controller 6. The casing 2 has a top surface 21, an upper side 22, a lower side 23, a left side surface 24, a right side surface 25, and a bottom side not illustrated.

The two channel operation units 3, the mode changeover switch 4, and the cross fader 5 are disposed on the top surface 21.

### Configuration of Channel Operation Units

The two channel operation units 3 respectively control playback states of the music pieces loaded to the channels. The two channel operation units 3 are a first channel operation unit 3A and a second channel operation unit 3B. The first channel operation unit 3A operates the playback state of the first music piece loaded to the first channel. The second channel operation unit 3B operates the playback state of the second music piece loaded to the second channel.

Each of the channel operation units 3A, 3B includes a jog wheel 31, an equalizer adjuster 32, a channel fader 33, and a tempo slider 34.

The jog wheel 31, which is rotatably provided on the top surface 21, is a dial used in adjusting a playback direction and playback speed of a music piece currently played. It should be noted that a so-called “scratching” unique to DJ performance is performed by a combination of user's operations for changing the rotary direction and the rotary speed of the jog wheel 31.

Each of the equalizer adjusters 32 performs an equalizer adjustment processing for the corresponding one of the channels. Specifically, the equalizer adjuster 32 of the first channel operation unit 3A performs the equalizer adjustment processing for the first channel and the equalizer adjuster 32 of the second channel operation unit 3B performs the equalizer adjustment processing for the second channel. Each of the equalizer adjusters 32 includes a level adjuster 321, a high-frequency band adjuster 322, a medium-frequency band adjuster 323, a low-frequency band adjuster 324, and an effect adjuster 325.

Each of the level adjuster 321, the high-frequency band adjuster 322, the medium-frequency band adjuster 323, the low-frequency band adjuster 324, and the effect adjuster 325 is a rotary encoder including a knob rotatable in opposite two directions around a rotation axis.

The level adjuster 321 adjusts an input level of the music piece inputted.

The effect adjuster 325 is an operator for adjusting the magnitude of the effect assigned to the corresponding one of the channel operation units 3.

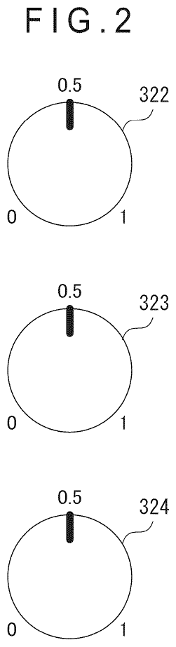

FIG. 2 schematically illustrates the high-frequency band adjuster 322, the medium-frequency band adjuster 323, and the low-frequency band adjuster 324. It should be noted that each of the high-frequency band adjuster 322, the medium-frequency band adjuster 323, and the low-frequency band adjuster 324 is positioned to point “0.5.”

The high-frequency band adjuster 322 adjusts a volume level of an inputted music piece in a high-frequency band. The high-frequency band is, for instance, a frequency band of 4649 Hz or more.

As illustrated in FIG. 2, the high-frequency band adjuster 322 adjusts the volume level in a range from 0 to 1. Supposing that the volume level set by the high-frequency band adjuster 322 is defined as a preset level, the preset level of the high-frequency band is 0 when the high-frequency band adjuster 322 is rotated to an anticlockwise limit position, and the preset level of the high-frequency band is 1 when the high-frequency band adjuster 322 is rotated to clockwise limit position. Specifically, the preset level of the high-frequency band is 0 when the high-frequency band adjuster 322 is positioned to point “0,” and the preset level of the high-frequency band is 1 when the high-frequency band adjuster 322 is positioned to point “1.” When the high-frequency band adjuster 322 is positioned to point “0.5,” the preset level of the high-frequency band is 0.5.

Hereinbelow, the preset level of the first music piece in the high-frequency band set by the high-frequency band adjuster 322 of the first channel operation unit 3A is defined as a preset level H1lv. The preset level of the second music piece in the high-frequency band set by the high-frequency band adjuster 322 of the second channel operation unit 3B is defined as a preset level H2lv. The preset level H1lv is a volume level set by a user using the high-frequency band adjuster 322 of the first channel operation unit 3A as the maximum level of the first music piece in the high-frequency band. The preset level H2lv is a volume level set by a user using the high-frequency band adjuster 322 of the second channel operation unit 3B as the maximum level of the second music piece in the high-frequency band.

The minimum volume level of the first music piece in the high-frequency band is defined as a minimum level H1 min and the minimum volume level of the second music piece in the high-frequency band is defined as a minimum level H2 min. The minimum level H1 min is smaller than the preset level H1lv and the minimum level H2 min is smaller than the preset level H2lv. Hereinbelow, the minimum levels H1 min and H2 min are supposed to be 0 for the convenience of description.

The medium-frequency band adjuster 323 adjusts a volume level of an inputted music piece in a medium-frequency band. The medium-frequency band is, for instance, a frequency band exceeding 284 Hz and less than 4649 Hz.

As illustrated in FIG. 2, the medium-frequency band adjuster 323 adjusts the volume level in a range from 0 to 1. The volume level is set by the medium-frequency band adjuster 323 in the same manner as the volume level is set by the high-frequency band adjuster 322.

Hereinbelow, the volume level set by the medium-frequency band adjuster 323 is defined as the preset level. Specifically, the preset level of the first music piece in the medium-frequency band preset by the medium-frequency band adjuster 323 of the first channel operation unit 3A is defined as a preset level M1lv. The preset level of the second music piece in the medium-frequency band preset by the medium-frequency band adjuster 323 of the second channel operation unit 3B is defined as a preset level M2lv. The preset level M1lv is a volume level set by a user using the medium-frequency band adjuster 323 of the first channel operation unit 3A as the maximum level of the first music piece in the medium-frequency band. The preset level M2lv is a volume level set by a user using the medium-frequency band adjuster 323 of the second channel operation unit 3B as the maximum level of the second music piece in the medium-frequency band.

The minimum volume level of the first music piece in the medium-frequency band is defined as a minimum level M1 min and the minimum volume level of the second music piece in the medium-frequency band is defined as a minimum level M2 min. The minimum level M1 min is smaller than the preset level M11v and the minimum level M2 min is smaller than the preset level M2lv. Hereinbelow, the minimum levels M1 min and M2 min are supposed to be 0 for the convenience of description.

The low-frequency band adjuster 324 adjusts a volume level of an inputted music piece in a low-frequency band. The low-frequency band is, for instance, a frequency band of 284 Hz or less.

As illustrated in FIG. 2, the low-frequency band adjuster 324 adjusts the volume level in a range from 0 to 1. The volume level is set by the low-frequency band adjuster 324 in the same manner as the volume level is set by the high-frequency band adjuster 322.

Hereinbelow, the volume level set by the low-frequency band adjuster 324 is defined as the preset level. Specifically, the preset level of the first music piece in the low-frequency band set by the low-frequency band adjuster 324 of the first channel operation unit 3A is defined as a preset level L1lv. The preset level of the second music piece in the low-frequency band set by the low-frequency band adjuster 324 of the second channel operation unit 3B is defined as a preset level L2lv. The preset level L1lv is a volume level set by a user using the low-frequency band adjuster 324 of the first channel operation unit 3A as the maximum level of the first music piece in the low-frequency band. The preset level L2lv is a volume level set by a user using the low-frequency band adjuster 324 of the second channel operation unit 3B as the maximum level of the second music piece in the low-frequency band.

The minimum volume level of the first music piece in the low-frequency band is defined as a minimum level L1 min and the minimum volume level of the second music piece in the low-frequency band is defined as a minimum level L2 min. The minimum level L1 min is smaller than the preset level L1lv and the minimum level L2 min is smaller than the preset level L2lv. Hereinbelow, the minimum levels L1 min and L2 min are supposed to be 0 for the convenience of description.

The channel fader 33 illustrated in FIG. 1 is an operator for adjusting the volume outputted by the corresponding one of the channel operation units 3. Specifically, the channel fader 33 of the first channel operation unit 3A, which is referred to as a first channel fader 33A, adjusts the volume outputted by the first channel operation unit 3A. The channel fader 33 of the second channel operation unit 3B, which is referred to as a second channel fader 33B, adjusts the volume outputted by the second channel operation unit 3B.

Each of the channel faders 33 includes a fader operator 331 slidable in up-and-down directions. When the fader operator 331 is operated in the up direction, a later-described volume adjuster 65 raises the volume of the entire music piece outputted by the corresponding one of the channel operation units 3. When the fader operator 331 is operated in the down direction, the volume adjuster 65 lowers the volume of the entire music piece outputted by the corresponding one of the channel operation units 3.

In the following description, the fader operators 331 of the first channel fader 33A and the second channel fader 33B are defined as a first operator 33A1 and a second operator 33B1, respectively. The first operator 33A1 adjusts the volume of the entire first music piece loaded to the first channel and the second operator 33B1 adjusts the volume of the entire second music piece loaded to the second channel.

In addition, the maximum volume of the entire first music piece is defined as a first preset volume set by the first operator 33A1 and the maximum volume of the entire second music piece is defined as a second preset volume set by the second operator 33B1.

Changing the volume of the entire music piece in accordance with the positions of the fader operators 331 refers to an increase or a decrease of the volume in each of the frequency bands by amplifying the high-frequency band signal having an intensity corresponding to the preset level of the high-frequency band, the mid-frequency band signal having an intensity corresponding to the preset level of the mid-frequency band, and the low-frequency band signal having an intensity corresponding to the preset level of the low-frequency band by amplification factors corresponding to the respective positions of the fader operators 331.

The tempo slider 34 illustrated in FIG. 1 is an operator for adjusting the playback speed of the music piece by adjusting playback BPM (Beats Per Minute) of the music piece loaded to corresponding one of the channels. It should be noted that the BPM of the music piece refer to the tempo of the music piece, that is, the number of beats in one minute. The BPM of the original music piece refer to the tempo of the original of the music piece, that is, the number of beats in one minute of the original. The playback BPM refer to the tempo of the music piece when the music piece is played, that is, the number of beats in one minute in playing the music piece.

The tempo slider 34 of the first channel operation unit 3A, which is referred to as a first tempo slider 34A, adjusts the playback BPM of the first music piece loaded to the first channel. The tempo slider 34 of the second channel operation unit 3B, which is referred to as a second tempo slider 34B, adjusts the playback BPM of the second music piece loaded to the second channel.

### Configuration of Mode Changeover Switch

The mode changeover switch 4 illustrated in FIG. 1 is a switch for switching the operation mode of the acoustic control device 1. The operation mode of the acoustic control device 1 is switched between the normal mode and the assist mode by pressing the mode changeover switch 4.

### Configuration of Cross Fader

The cross fader 5 illustrated in FIG. 1, which includes a fader operator 51 movable leftward and rightward, is an operator for adjusting a balance between the volume of the first music piece loaded to the first channel and the volume of the second music piece loaded to the second channel. According to the later-described normal mode, the ratio of the volume of the first music piece in the volume outputted by the acoustic control device 1 increases as the fader operator 51 is moved leftward. The ratio of the volume of the second music piece in the volume outputted by the acoustic control device 1 increases as the fader operator 51 is moved rightward.

Specifically, the volume of the first music piece is maximized and the volume of the second music piece is minimized when the fader operator 51 is positioned at a left end. The volume of the first music piece is minimized and the volume of the second music piece is maximized when the fader operator 51 is positioned at a right end.

Hereinbelow, one of the ends of an operable range RC of the fader operator 51 is defined as a first end TC1 and the other end is defined as a second end TC2. In the exemplary embodiment, since the fader operator 51 moves leftward and rightward, the first end TC1 refers to the left end of the operable range RC and the second end TC2 refers to the right end of the operable range RC.

### Configuration of Controller

FIG. 3 is a block diagram illustrating a configuration of the controller 6.

The controller 6, which is provided by a circuit board including at least one processor (e.g. a CPU (Central processing unit)), reads and runs an acoustic control program stored in a storage (not illustrated) in a manner readable by a computer. In other words, the processor of the controller 6 is a computer and the controller 6 controls the operation of the acoustic control device 1 based on the acoustic control program. Specifically, the controller 6 plays the music piece loaded to each of the channels and adjusts how the first and second music pieces are mixed based on the operation of the cross fader 5 and the channel faders 33A, 33B.

As illustrated in FIG. 3, the controller 6 includes a first playback unit 61, a second playback unit 62, a position acquisition unit 63, a mode switching unit 64, and a volume adjuster 65.

The first playback unit 61 plays the first music piece loaded to the first channel. Specifically, the first playback unit 61 plays the first music piece at the BPM of the original of the first music piece. It should be noted that, when the BPM in playing the first music piece have been adjusted by the first tempo slider 34A, the first playback unit 61 plays the first music piece at the playback BPM after being adjusted.

The second playback unit 62 plays the second music piece loaded to the second channel. Specifically, the second playback unit 62 plays the second music piece at the BPM of the original of the second music piece. It should be noted that, when the BPM in playing the second music piece have been adjusted by the second tempo slider 34B, the second playback unit 62 plays the second music piece at the playback BPM after being adjusted.

The position acquisition unit 63 acquires the position of each of the operators. For instance, the position acquisition unit 63 acquires the position of the fader operator 331 in the operable range of each of the channel faders 33, the position of each of the tempo sliders 34 in the operable range, and the position of the fader operator 51 in the operable range of the cross fader 5.

Specifically, the position acquisition unit 63 acquires a numerical value representing the position of the first operator 33A1, which is 0 when the first operator 33A1 is positioned at a later-described first end TA1 of the operable range and is 1 when the first operator 33A1 is positioned at a later-described second end TA2. Similarly, the position acquisition unit 63 acquires a numerical value representing the position of the second operator 33B1, which is 0 when the second operator 33B1 is positioned at a later-described first end TB1 of the operable range and is 1 when the second operator 33B1 is positioned at a later-described second end TB2.

The position acquisition unit 63 also acquires a numerical value representing a relative position of the fader operator 51, which is 0 when the fader operator 51 is positioned at a later-described first end TC1 of the operable range and is 1 when the fader operator 51 is positioned at a later-described second end TC2.

The operation mode of the acoustic control device 1 is switched by the mode switching unit 64 between the normal mode and the assist mode in accordance with an input operation of the mode changeover switch 4. As detailed later, in the normal mode, the acoustic control device 1 does not assist the mixing operation of the first and second music pieces. As detailed later, in the normal mode, the acoustic control device 1 does not assist the mixing operation of the first and second music pieces.

### Function of Volume Adjuster

The volume adjuster 65 adjusts the volume of the first music piece outputted through the first channel, the volume of the second music piece outputted through the second channel, and, in addition, the balance between the volume of the first music piece and the volume of the second music piece based on the position of the fader operator 51 and each of the operators 33A1, 3381 acquired by the position acquisition unit 63. Specifically, the volume adjuster 65 adjusts the balance between the volume of the first music piece and the volume of the second music piece in accordance with the position of the fader operator 51. The volume adjuster 65 also adjusts the volume of the first music piece in accordance with the position of the first operator 33A1 of the first channel fader 33A and the volume of the second music piece in accordance with the position of the second operator 33B1 of the second channel fader 33B.

### Volume Adjustment by Cross Fader in Normal Mode

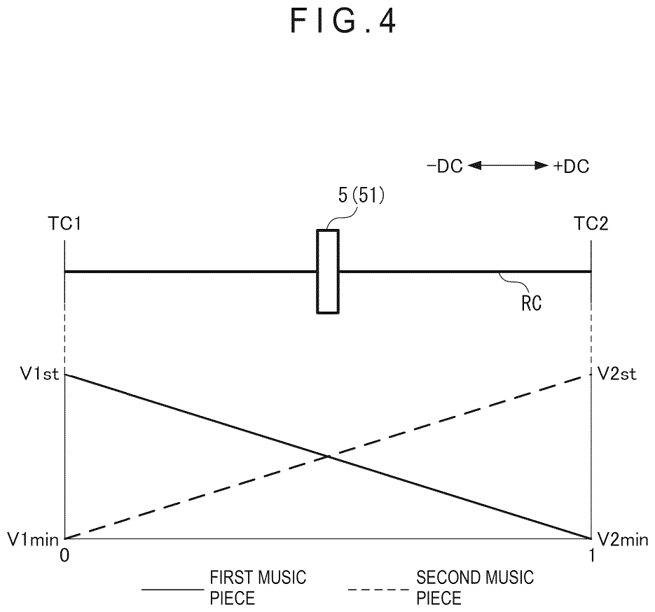

FIG. 4 illustrates a change in volume of the entire first music piece and a change in volume of the entire second music piece when the cross fader 5 is operated in the normal mode. It should be noted that a numerical value showing the relative position of the fader operator 51 acquired by the position acquisition unit 63 is plotted on the abscissa axis of the graph illustrated in FIG. 4.

When the operation mode of the acoustic control device 1 is the normal mode, the volume adjuster 65 adjusts the balance between the volume of the entire first music piece and the volume of the entire second music piece in accordance with the position of the fader operator 51 of the cross fader 5 in the operable range. It should be noted that the volume of the entire first music piece refers to a total of the volume of the first music piece in the high-frequency band, the volume in the medium-frequency band, and the volume in the low-frequency band. The maximum value of the volume of the entire first music piece is referred to as a first preset volume V1st set by the first operator 33A1. The balance between the high-frequency band, the medium-frequency band, and the low-frequency band of the first music piece corresponds to a ratio between the preset level H1lv of the high-frequency band, the preset level M1lv of the medium-frequency band, and the preset level L1lv of the low-frequency band. Similarly, the maximum value of the volume of the entire second music piece is referred to as a second preset volume V2st set by the second operator 3381. The balance between the high-frequency band, the medium-frequency band, and the low-frequency band of the second music piece corresponds to a ratio between the preset level H2lv of the high-frequency band, the preset level M2lv of the medium-frequency band, and the preset level L2lv of the low-frequency band.

It should be noted that, as illustrated in FIG. 4, a direction oriented from the first end TC1 toward the second end TC2 is defined as a +DC direction, whereas a direction oriented from the second end TC2 toward the first end TC1 is defined as a −DC direction.

Specifically, as illustrated in FIG. 4, when the fader operator 51 is positioned at the first end TC1, the volume adjuster 65 sets the volume of the entire first music piece at the above-described first preset volume V1st and the volume of the entire second music piece at a second minimum volume V2 min.

As the fader operator 51 is operated from the first end TC1 in the +DC direction, the volume adjuster 65 lowers the volume of the entire first music piece and raises the volume of the entire second music piece. In other words, as the fader operator 51 is operated from the second end TC2 in the −DC direction, the volume adjuster 65 raises the volume of the entire first music piece and lowers the volume of the entire second music piece.

The ratio of the second music piece in the volume outputted by the acoustic control device 1 thus increases as the fader operator 51 is operated in the +DC direction. The ratio of the first music piece in the volume outputted by the acoustic control device 1 increases as the fader operator 51 is operated in the −DC direction.

When the fader operator 51 is positioned at the second end TC2, the volume adjuster 65 sets the volume of the entire first music piece at the first minimum volume V1 min and the volume of the entire second music piece at the above-described second preset volume V2st.

As described above, when the operation mode of the acoustic control device 1 is the normal mode, the volume of the entire first music piece and the volume of the entire second music piece are adjusted in accordance with the position of the fader operator 51 in the operable range RC. Then, the outputted music piece is switched from the first music piece to the second music piece by operating the fader operator 51 from the first end TC1 to the second end TC2. The outputted music piece is switched from the second music piece to the first music piece by operating the fader operator 51 from the second end TC2 to the first end TC1.

The volume level of each of the music pieces in each of the frequency bands when the cross fader 5 is operated in the normal mode will be described below.

As described above, the volume of the entire music piece is determined by amplifying the high-frequency band signal having an intensity corresponding to the preset level of the high-frequency band, the mid-frequency band signal having an intensity corresponding to the preset level of the mid-frequency band, and the low-frequency band signal having an intensity corresponding to the preset level of the low-frequency band by amplification factors corresponding to the respective positions of the fader operators 331. In other words, when the positions of the fader operators 331 are not changed, the volume of the entire music pieces and, consequently, the volume balance between the music pieces are adjusted by changing the volume level of each of the frequency bands (upper limit: the preset level).

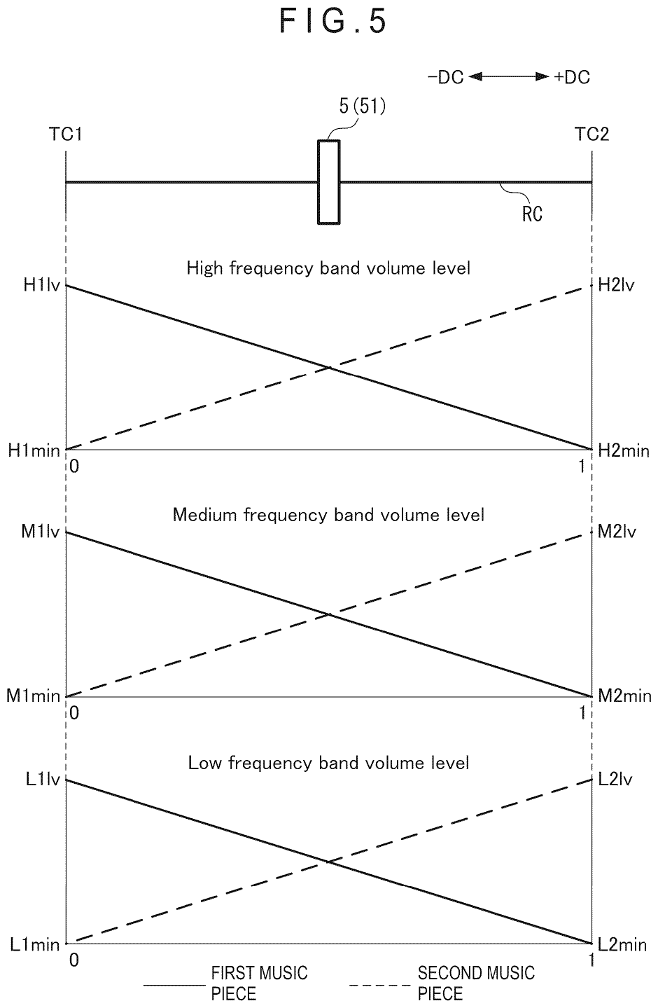

FIG. 5 illustrates a change in volume level of each of frequency bands of the first music piece and a change in volume level of each of frequency bands of the second music piece when the cross fader is operated in the normal mode. Specifically, the first row from the top in FIG. 5 illustrates the position of the fader operator 51 and the second row from the top in FIG. 5 illustrates the volume level of each of the first and second music pieces in the high-frequency band. The third row from the top in FIG. 5 illustrates the volume level of each of the music pieces in the medium-frequency band, and the fourth row from the top in FIG. 5 illustrates the volume level of each of the music pieces in the low-frequency band. It should be noted that the numerical values showing the above-described relative position of the fader operator 51 are plotted on the abscissa axis of the graph illustrated at each of the second, third, and fourth rows in FIG. 5. The preset level H1lv and the preset level H2lv, which are illustrated as the same value in FIG. 5, are not necessarily the same value. The same applies to the preset levels M11v, M2lv and the preset levels L11v, L2lv.

As illustrated in FIG. 5, the volume adjuster 65 adjusts the volume of each of the entire music pieces by changing the volume level of the music pieces in each of the frequency bands in accordance with the position of the fader operator 51 as illustrated in FIG. 4.

Specifically, as illustrated in the first and second rows in FIG. 5, the volume adjuster 65 changes, in accordance with the position of the fader operator 51 in the operable range RC, the volume level of the first music piece in the high-frequency band within the range from the minimum level H1 min to the preset level H1lv and changes the volume level of the second music piece in the high-frequency band within the range from the minimum level H2 min to the preset level H2lv. Specifically, as the fader operator 51 is operated from the first end TC1 in the +DC direction, the volume adjuster 65 raises the volume level of the first music piece in the high-frequency band from the minimum level H1 min (upper limit: the preset level H1lv) and lowers the volume level of the second music piece in the high-frequency band from the preset level H2lv (lower limit: the minimum level H2 min).

Similarly, as illustrated in the third and fourth rows in FIG. 5, the volume adjuster 65 changes the volume level of the first music piece in the medium-frequency band within the range from the minimum level M1 min to the preset level M11v and changes the volume level of the first music piece in the low-frequency band within the range from the minimum level L1 min to the preset level L1lv in accordance with the position of the fader operator 51 in the operable range RC. The volume adjuster 65 also changes the volume level of the second music piece in the medium-frequency band within the range from the minimum level M2 min to the preset level M2lv and changes the volume level of the second music piece in the low-frequency band within the range from the minimum level L2 min to the preset level L2lv in accordance with the position of the fader operator 51 in the operable range RC. Specifically, as the fader operator 51 is operated from the first end TC1 in the +DC direction, the volume adjuster 65 raises the volume level of the first music piece in the medium-frequency band from the minimum level M1 min (upper limit: the preset level M1iv) and lowers the volume level of the second music piece in the medium-frequency band from the preset level M2lv (lower limit: the minimum level M2 min). As the fader operator 51 is operated from the first end TC1 in the +DC direction, the volume adjuster 65 raises the volume level of the first music piece in the low-frequency band from the minimum level L1 min (upper limit: the preset level L11v) and lowers the volume level of the second music piece in the low-frequency band from the preset level L2lv (lower limit: the minimum level L2 min).

The volume of the first music piece and the volume of the second music piece are thus adjusted by the volume adjuster 65, which adjusts the volume level of each of the music pieces in each of the frequency bands in accordance with the position of the fader operator 51 between the minimum level and the preset level, thereby adjusting the volume balance between the music pieces.

### Volume Adjustment by Cross Fader in Assist Mode

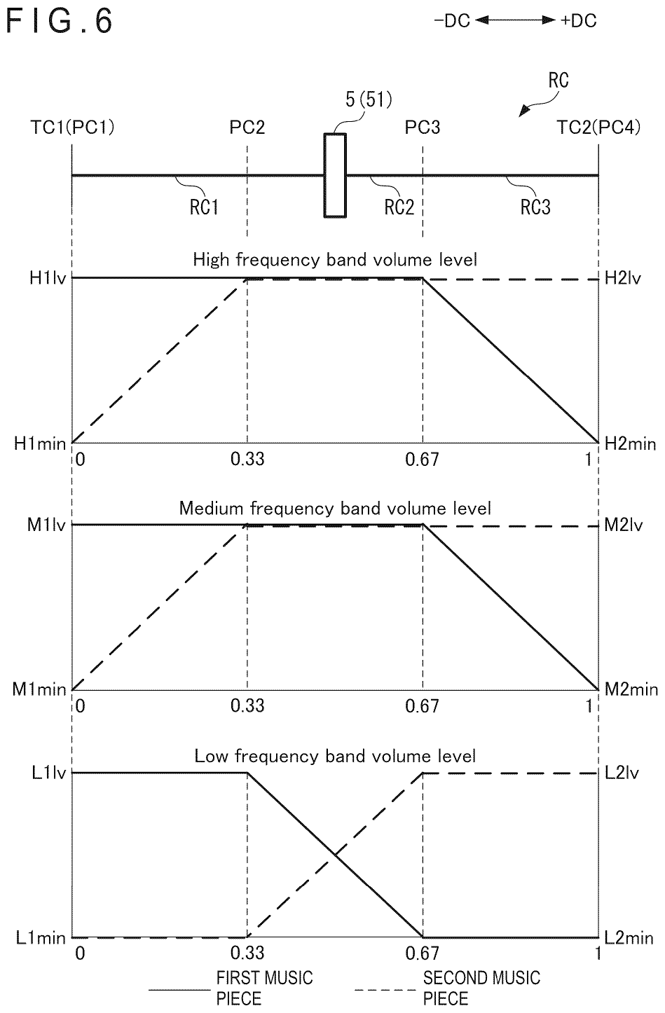

FIG. 6 illustrates a change in volume level of each of frequency bands of the first music piece and a change in volume level of each of frequency bands of the second music piece when the cross fader is operated in the assist mode. Specifically, FIG. 6 illustrates a change in volume level of each music piece in each frequency band when the cross fader 5 is operated in the assist mode. It should be noted that a numerical value showing the relative position of the fader operator 51 is plotted on the abscissa axis of the graph shown in FIG. 6. The preset level H1lv and the preset level H2lv, which are illustrated as the same value in FIG. 6, are not necessarily the same value. The same applies to the preset levels M1lv, M2lv and the preset levels L11v, L2lv.

When the operation mode of the acoustic control device 1 is the assist mode, the volume adjuster 65 adjusts the volume level of the first music piece in each of the high-frequency band, the medium-frequency band, and the low-frequency band and the volume level of the second music piece in each of the high-frequency band, the medium-frequency band, and the low-frequency band in accordance with the range for the fader operator 51 to be positioned within the operable range RC of the fader operator 51 as illustrated in FIG. 6. The volume adjuster 65 thus adjusts the volume of each of the music pieces to adjust the volume balance between the music pieces in accordance with the position of the fader operator 51.

It should be noted that the operable range RC of the fader operator 51 includes a first section RC1, a second section RC2, and a third section RC3 in the assist mode.

The first section RC1 is a section between a first position PC1 and a second position PC2. The second position PC2 is located in the +DC direction with respect to the first position PC1.

The second section RC2 is a section between the second position PC2 and a third position PC3. The third position PC3 is located in the +DC direction with respect to the second position PC2.

The third section RC3 is a section between the third position PC3 and a fourth position PC4. The fourth position PC4 is located in the +DC direction with respect to the third position PC3.

In the exemplary embodiment, the first position PC1 and the fourth position PC4 are defined at the first end TC1 and the second end TC2, respectively. The first section RC1 refers to a section defining one third of the operable range RC from the first end TC1. The second section RC2 refers to a section defining one third of the operable range RC from the second position PC2. The third section RC3 refers to a section defining one third of the operable range RC from the third position PC3.

When the operation mode is the assist mode and the fader operator 51 is positioned at the first end TC1, the volume adjuster 65 sets the volume level of the first music piece in each of the wavelength bands at the respective preset levels H1lv, M1lv, L1lv of the first music piece in the corresponding frequency bands and sets the volume level of the second music piece in each of the wavelength bands at the respective minimum levels H2 min, M2 min, L2 min of the second music piece in the corresponding frequency bands. Thus, the volume of the entire first music piece becomes the first preset volume V1st and the volume of the entire second music piece becomes the second minimum volume V2 min.

When the operation mode is the assist mode and the fader operator 51 is positioned within the first section RC1, the volume adjuster 65 raises the volume level of the second music piece in each of the high-frequency and medium-frequency bands in accordance with the operation of the fader operator 51 in the +DC direction while keeping the volume level of the first music piece in each of the wavelength bands at the respective preset levels H1v, M11v, L11v and the volume level of the second music piece in the low-frequency band at the minimum level L2 min. In other words, the volume levels to be changed in the first section RC1 are the volume levels of the second music piece in the high-frequency band and the medium-frequency band.

In the first section RC1, the volume level of the second music piece in the high-frequency band is changed within a range from the minimum level H2 min to the preset level H2lv of the second music piece in the high-frequency band.

In the first section RC1, the volume level of the second music piece in the medium-frequency band is changed within a range from the minimum level M2 min to the preset level M2lv of the second music piece in the medium-frequency band.

When the fader operator 51 is positioned at the second position PC2, the volume adjuster 65 sets the volume level of the first music piece in each of the frequency bands at the respective preset levels H1lv, M11v, L11v, sets the volume level of the second music piece in the high-frequency band at the preset level H2lv, and sets the volume level of the second music piece in the medium-frequency band at the preset level M2lv while keeping the volume level of the second music piece in the low-frequency band at the minimum level L2 min.

When the operation mode is the assist mode and the fader operator 51 is positioned within the second section RC2, the volume adjuster 65 lowers the volume level of the first music piece in the low-frequency band from the preset level L1lv and raises the volume level of the second music piece in the low-frequency band from the minimum level L2 min in accordance with the operation of the fader operator 51 in the +DC direction while keeping the volume level of the first music piece in the high-frequency and medium-frequency bands at the preset levels H1lv and M11v, respectively, and the volume level of the second music piece in the medium-frequency band at the preset level M21v. In other words, the volume levels to be changed in the second section RC2 are the volume levels of the first and second music pieces in the low-frequency bands.

In the second section RC2, the volume level of the first music piece in the low-frequency band is changed within a range from the minimum level L1 min to the preset level L1lv of the first music piece in the low-frequency band.

In the second section RC2, the volume level of the second music piece in the low-frequency band is changed within a range from the minimum level L2 min to the preset level L2lv of the second music piece in the low-frequency band.

When the preset level L1lv and the minimum level L1 min of the first music piece in the low-frequency band are respectively the same as the preset level L2lv and the minimum level L2 min of the second music piece in the low-frequency band, the volume adjuster 65 equalizes the volume level of the first music piece in the low-frequency band and the volume level of the second music piece in the low-frequency band when the fader operator 51 is positioned at the center of the second section RC2.

Accordingly, a magnitude relationship between the volume level of the first music piece in the low-frequency band and the volume level of the second music piece in the low-frequency band and, consequently, a magnitude relationship between the volume of the first music piece in the low-frequency band and the volume of the second music piece in the low-frequency band are switched by changing the direction for operating the fader operator 51 (i.e. in the +DC direction or −DC direction) with respect to the center of the second section RC2. Specifically, when the fader operator 51 is operated in the +DC direction with respect to the center of the second section RC2, the volume of the second music piece in the low-frequency band becomes larger than the volume of the first music piece in the low-frequency band. In contrast, when the fader operator 51 is operated in the −DC direction with respect to the center of the second section RC2, the volume of the first music piece in the low-frequency band becomes larger than the volume of the second music piece in the low-frequency band.

It should be noted that the center of the second section RC2 is at the same position as the center of the operable range RC.

In the exemplary embodiment, the respective change rates of the volume levels of the first and second music pieces in the low-frequency bands in the second section RC2 are constant. Accordingly, when the fader operator 51 is operated in the +DC direction from the second position PC2, the volume level of the first music piece in the low-frequency band falls at a constant rate whereas the volume level of the second music piece in the low-frequency band rises at a constant rate. When the fader operator 51 is operated in the −DC direction from the third position PC3, the volume level of the first music piece in the low-frequency band rises at a constant rate whereas the volume level of the second music piece in the low-frequency band falls at a constant rate.

However, the respective change rates of the volume levels of the first and second music pieces in the low-frequency bands in the second section RC2 are not necessarily defined as the above but are optionally not constant. For instance, when the fader operator 51 is operated in the +DC direction in the second section RC2, the volume level of the first music piece in the low-frequency band optionally falls along a predetermined curve whereas the volume level of the second music piece in the low-frequency band optionally rises along a predetermined curve. In other words, the change rate of the volume level of each of the music pieces in the low-frequency band is optionally changed depending on the operation of the fader operator 51.

When the fader operator 51 is positioned at the third position PC3, the volume adjuster 65 sets the volume level of the first music piece in the low-frequency band at the minimum level L1 min and sets the volume level of the second music piece in the low-frequency band at the preset level L2lv while keeping the volume level of the first music piece in the high-frequency band at the preset level H1lv, the volume level of the first music piece in the medium-frequency band at the preset level M1lv, the volume level of the second music piece in the high-frequency frequency band at the preset level H2lv, and the volume level of the second music piece in the medium-frequency band at the preset level M2lv.

When the operation mode is the assist mode and the fader operator 51 is positioned within the third section RC3, the volume adjuster 65 lowers the volume levels of the first music piece in the high-frequency and medium-frequency bands from the preset level H1lv and the preset level M11v, respectively, in accordance with the operation of the fader operator 51 in the +DC direction while keeping the volume level of the first music piece in the low-frequency band at the minimum level L1 min and the volume levels of the second music piece in the high-frequency, medium-frequency, and low-frequency bands at the respective preset levels H2lv, M2lv, and L2lv. In other words, the volume levels to be changed in the third section RC3 are the volume levels of the first music piece in the high-frequency band and the medium-frequency band.

In the third section RC3, the volume level of the first music piece in the high-frequency band is changed within a range from the minimum level H1 min to the preset level H1lv of the first music piece in the high-frequency band.

In the third section RC3, the volume level of the first music piece in the medium-frequency band is changed within a range from the minimum level M1 min to the preset level M1lv of the first music piece in the medium-frequency band.

When the fader operator 51 is positioned at the fourth position PC4 (i.e. when the fader operator 51 is positioned at the second end TC2), the volume adjuster 65 sets the respective volume levels of the first music piece in the high-frequency band, the medium-frequency band, and the low-frequency band at the minimum levels H1 min, M1 min, and L1 min and sets the respective volume levels of the second music piece in the high-frequency band, the medium-frequency band, and the low-frequency band at the preset levels H2lv, M2lv, and L2lv. The volume of the entire first music piece thus becomes the first minimum volume V1 min and the volume of the entire second music piece becomes the second preset volume V2st as illustrated in FIG. 4, thereby completing the mixing operation from the first music piece to the second music piece.

### Setting of Minimum Level

The minimum levels H1 min, M1 min, L1 min, H2 min, M2 min, and L2 min, which are each 0 in the above for the convenience of description, are not necessarily determined as described above but at least one of the minimum levels H1 min, M1 min, L1 min, H2 min, M2 min, and L2 min is optionally not 0.

For instance, at least one of the minimum levels H1 min, M1 min, L1 min, H2 min, M2 min, and L2 min is optionally determined in accordance with the value of the corresponding one of the preset levels H1lv, M1lv, L11v, H2lv, M2lv, and L2lv.

More specifically, the minimum level H1 min is optionally 0 when the preset level H1lv of the first music piece in the high-frequency band is in a range from 0 to 0.5. Alternatively, the minimum level H1 min is optionally determined to be a value obtained by subtracting 0.5 from the preset level H11v when the preset level H11v exceeds 0.5 and 1 or less. The same applies to setting of the minimum levels M1 min, L1 min, H2 min, M2 min, and/or L2 min when the respective preset levels M1lv, L1lv, H2lv, M2lv, and L2lv are 0 or more and less than 0.5.

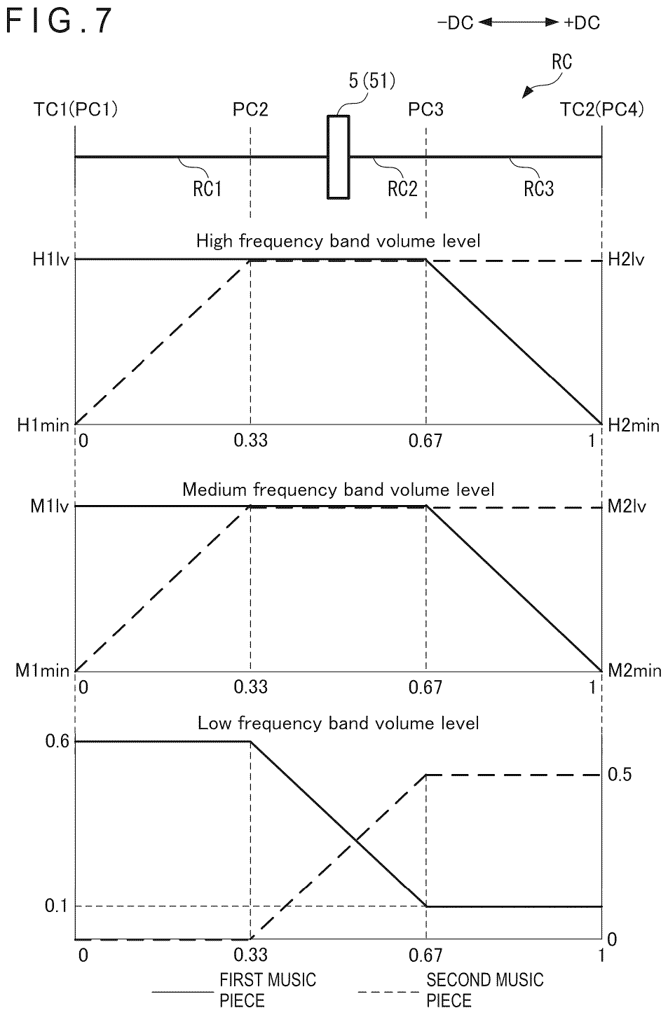

FIG. 7 illustrates a change in volume level of the first music piece in each frequency band and a change in volume level of the second music piece in each frequency band when the preset level 11v of the first music piece in the low-frequency band is 0.6 and the preset level L2lv of the second music piece in the low-frequency band is 0.5.

For instance, when the preset level L11v of the first music piece in the low-frequency band is set at 0.6 by the low-frequency band adjuster 324, the minimum level of the first music piece in the low-frequency band is optionally set at 0.1 as illustrated in FIG. 7.

Even in this case, the volume of the first music piece and the volume of the second music piece can also be switched by operating the fader operator 51. Especially, the volume of the first music piece and the volume of the second music piece can also be switched by operating the fader operator 51 within the second section RC2 irrespective of the volumes of the music pieces in the high-frequency band and medium-frequency band.

It should be noted that the difference between the preset level and the minimum level is not necessarily 0.5 but is changeable as desired.

### Volume Adjustment by Channel Fader in Normal Mode

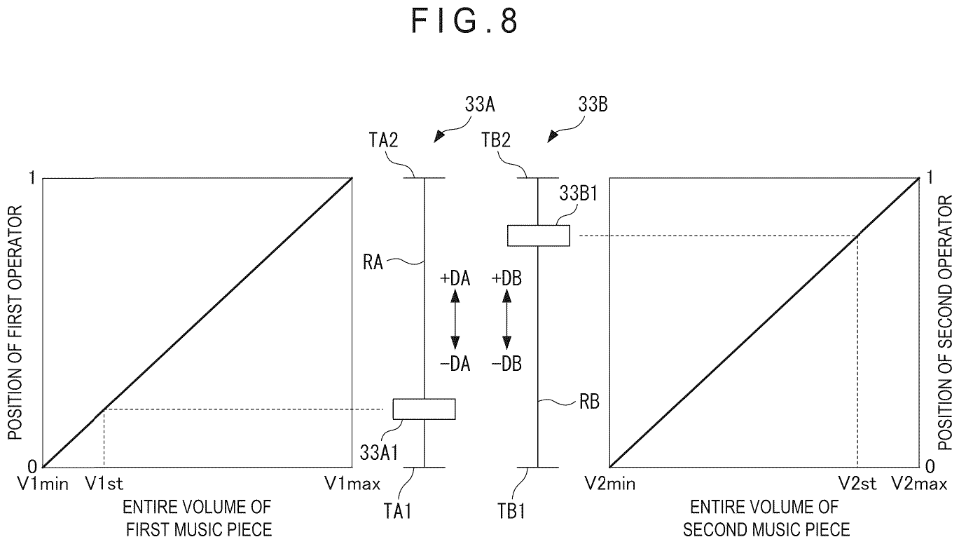

FIG. 8 illustrates an example of a change in volume of the entire first music piece when the first channel fader 33A is operated and an example of a change in volume of the entire second music piece when the second channel fader 33B is operated, in the normal mode.

When the operation mode of the acoustic control device 1 is the normal mode, the volume adjuster 65 adjusts the volume of the entire first music piece in accordance with the position of the first operator 33A1 of the first channel fader 33A and the volume of the entire second music piece in accordance with the position of the second operator 33B1 of the second channel fader 33B, as illustrated in FIG. 8. Specifically, the volume adjuster 65 sets the first preset volume V1st (i.e. the volume of the entire first music piece) in a range from the first minimum volume V1 min to a first maximum volume V1max on a basis of the position of the first operator 33A1. The volume adjuster 65 also sets the second preset volume V2st (i.e. the volume of the entire second music piece) in a range from the second minimum volume V2 min to a second maximum volume V2max on a basis of the position of the second operator 3381.

It should be noted that the first maximum volume V1max and the second maximum volume V2max are respectively the maximum volume of the entire first music piece and the maximum volume of the entire second music piece that can be outputted from the acoustic control device 1.

Hereinbelow, one of the ends of an operable range RA of the first operator 33A1 is defined as the first end TA1 and the other end is defined as the second end TA2. A direction oriented from the first end TA1 toward the second end TA2 is defined as a +DA direction, whereas a direction oriented from the second end TA2 toward the first end TA1 is defined as a −DA direction.

A lower one of the ends of an operable range RB of the second operator 33B1 is defined as a first end TB1 and the other upper end is defined as a second end TB2. A direction oriented from the first end TB1 toward the second end TB2 is defined as a +DB direction, whereas a direction oriented from the second end TB2 toward the first end TB1 is defined as a −DB direction.

In the exemplary embodiment, in view of the orientation of the +DA and +DB directions (i.e. upward directions), the first ends TA1 and TB1 are each at the lower end of the corresponding one of the operable ranges RA, RB, and the second ends TA2, TB2 are each at the upper end of the corresponding one of the operable ranges RA, RB.

Specifically, when the first operator 33A1 is positioned at the first end TA1, the volume adjuster 65 sets the first preset volume V1st at the first minimum volume V1 min. The volume of the entire first music piece thus becomes the first minimum volume V1 min.

When the first operator 33A1 is operated, the volume adjuster 65 changes the first preset volume V1st. Specifically, when the first operator 33A1 is operated in the +DA direction, the volume adjuster 65 raises the first preset volume V1st to raise the volume of the entire first music piece. When the first operator 33A1 is operated in the −DA direction, the volume adjuster 65 lowers the first preset volume V1st to lower the volume of the entire first music piece. The first preset volume V1st is changed as described above to change the volume of the entire first music piece.

In the example illustrated in FIG. 8, the change rate of the volume of the entire first music piece is constant, where the amount of the movement of the first operator 33A1 is in direct proportion to the the amount of the change in the first preset volume V1st and the amount of the change in the volume of the entire first music piece. However, the change rate of the first preset volume V1st and the change rate of the volume of the entire first music piece, which are not necessarily constant, are, for instance, optionally to be changed in accordance with the operation of the first operator 33A1 in the +DA direction or the −DA direction.

When the first operator 33A1 is positioned at the second end TA2, the volume adjuster 65 sets the first preset volume V1st at the first maximum volume V1max. The volume of the entire first music piece thus becomes the first maximum volume V1max.

Meanwhile, when the second operator 33B1 is positioned at the first end TB1, the volume adjuster 65 sets the second preset volume V2st at the second minimum volume V2 min. The volume of the entire second music piece thus becomes the second minimum volume V2 min.

When the second operator 3381 is operated, the volume adjuster 65 changes the second preset volume V2st. Specifically, when the second operator 33B1 is operated in the +DB direction, the volume adjuster 65 changes the second preset volume V2st in accordance with the position of the second operator 33B1 to raise the volume of the entire second music piece. When the second operator 3381 is operated in the −DB direction, the volume adjuster 65 lowers the second preset volume in accordance with the position of the second operator 33B1 to lower the volume of the entire second music piece. At this time, each of the change rate of the second preset volume V2st and the change rate of the volume of the entire second music piece, which are constant in the example illustrated in FIG. 8, are optionally not constant. The change rate of the second preset volume V2st and the change rate of the volume of the entire second music piece are, for instance, optionally to be changed in accordance with the operation of the second operator 33B1 in the +DA direction or the −DA direction.

When the second operator 33B1 is positioned at the second end TB2, the volume adjuster 65 sets the second preset volume V2st at the second maximum volume V2max. The volume of the entire second music piece thus becomes the second maximum volume V2max.

Accordingly, the music piece outputted by the acoustic control device 1 can be switched from the first music piece to the second music piece, for instance, by operating the first operator 33A1 in the −DA direction and operating the second operator 3381 in the +DB direction from a state where the first operator 33A1 is positioned at the second end TA2 and the second operator 3381 is positioned at the first end TB1.

### Volume Adjustment by Channel Fader in Assist Mode

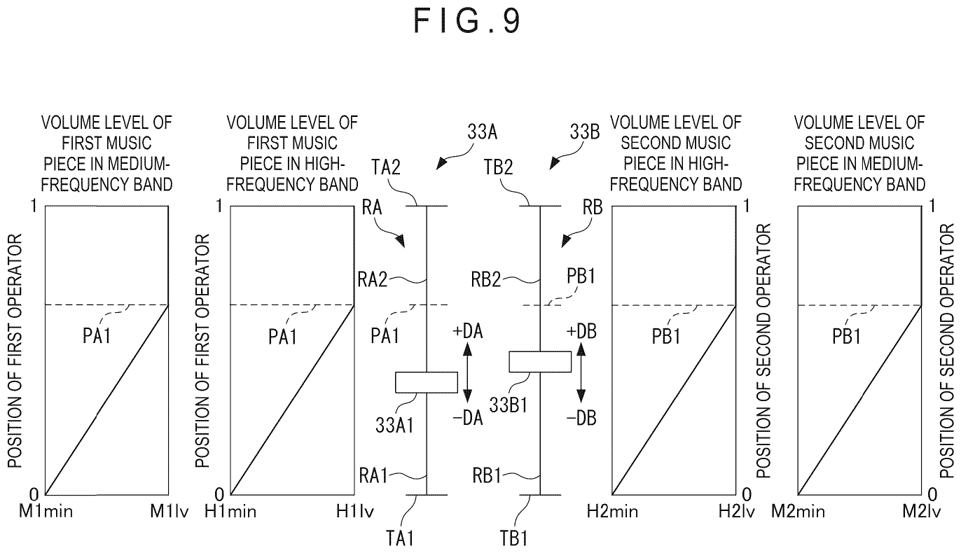

FIG. 9 illustrates a change in volume level of the first music piece in the high-frequency band and the medium-frequency band and a change in volume level of the second music piece in the high-frequency band and the medium-frequency band, when the respective channel faders 33A, 33B are operated in the assist mode.

When the operation mode of the acoustic control device 1 is the assist mode, the volume adjuster 65 adjusts the volume level of the first music piece in each of the frequency bands in accordance with the position for the first operator 33A1 to be located within the operable range RA to adjust the volume of the first music piece. When the operation mode of the acoustic control device 1 is the assist mode, the volume adjuster 65 also adjusts the volume level of the second music piece in each of the frequency bands in accordance with the position for the second operator 3381 to be located within the operable range RB to adjust the volume of the second music piece.

As illustrated in FIG. 9, a position PA1 is defined at a predetermined position between the first end TA1 and the second end TA2 in the operable range RA of the first operator 33A1. The position PA1 is optionally at one third of the operable range RA from the second end TA2. A first section RA1 is defined by a section from the first end TA1 to the position PA1. A second section RA2 is defined by a section from the position PA1 to the second end TA2.

A position PB1 is defined at a predetermined position between the first end TB1 and the second end TB2 in the operable range RB of the second operator 33B1. The position PB1 is optionally at one third of the operable range RB from the second end TB2. A first section RB1 is defined by a section from the first end TB1 to the position PB1. A second section RB2 is defined by a section from the position PB1 to the second end TB2.

### Volume Adjustment in First Section of Channel Fader

As illustrated in FIG. 9, the volume adjuster 65 adjusts the volume levels of the first second music piece in the high-frequency and medium-frequency bands in accordance with the position of the first operator 33A1 in the first section RA1, and adjusts the volume levels of the second music piece in the high-frequency and medium-frequency bands in accordance with the position of the second operator 33B1 in the first section RB1.

It should be noted that the first preset volume V1st and the second preset volume V2st are respectively preset based on the positions of the first operator 33A1 and the second operator 3381. For instance, the first preset volume V1st is optionally determined as a volume corresponding to the position of the first operator 33A1 when the mode changeover switch 4 is pressed to switch the operation mode to the assist mode by the mode switching unit 64. The second preset volume V2st is optionally determined as a volume corresponding to the position of the second operator 3381 when the mode changeover switch 4 is pressed to switch the operation mode to the assist mode by the mode switching unit 64. However, the first preset volume V1st is not necessarily determined as described above but is optionally preset through other process or using other operator(s). The same applies to the second preset volume V2st.

When the first operator 33A1 is positioned at the first end TA1 in the assist mode, the volume adjuster 65 sets the volume levels of the first music piece in the high-frequency band, the medium-frequency band, and the low-frequency band at the minimum level H1 min, M1 min, and L1 min, respectively, and sets the volume of the entire first music piece at the first minimum volume V1 min.

When the first operator 33A1 is operated while being positioned within the first section RA1, the volume adjuster 65 adjusts the volume level of the first music piece in the high-frequency band within a range from the minimum level H1 min to the preset level H1lv and the volume level of the first music piece in the medium-frequency band within a range from the minimum level M1 min to the preset level M11v in accordance with the position of the first operator 33A1 as illustrated in FIG. 9, while keeping the volume level of the first music piece in the low-frequency band at the minimum level L1 min (not illustrated in FIG. 9). Specifically, within the first section RA1, the volume adjuster 65 raises the volume levels of the first music piece in the high-frequency and medium-frequency bands when the first operator 33A1 is operated within the first section RA1 in the +DA direction and the volume adjuster 65 lowers the volume levels of the first music piece in the high-frequency and medium-frequency bands when the first operator 33A1 is operated in the −DA direction. The volume of the entire first music piece thus changes. It should be noted that the change rate of the volume level of the first music piece in each of the high-frequency band and the medium-frequency band, which is constant in the example illustrated in FIG. 9, is optionally not constant. For instance, the change rate is optionally changed in accordance with the operation of the first operator 33A1 in the ±DA directions.

When the first operator 33A1 is positioned at the position PA1, the volume adjuster 65 sets the volume level of the first music piece in the high-frequency and medium-frequency bands at the preset levels H11v and M11v, respectively, while keeping the volume level of the first music piece in the low-frequency band at the minimum level L1 min.

As described above, the change in the volume of the first music piece when the first operator 33A1 is positioned within the first section RA1 is the same as the change in the volume of the first music piece when the fader operator 51 is positioned within the third section RC3.

When the second operator 3381 is positioned at the first end TB1 in the assist mode, the volume adjuster 65 sets the volume levels of the second music piece in the high-frequency band, the medium-frequency band, and the low-frequency band at the minimum level H2 min, M2 min, and L2 min, respectively, and sets the volume of the entire second music piece at the second minimum volume V2 min.

When the second operator 33B1 is operated while being positioned within the first section RB1, the volume adjuster 65 adjusts the volume level of the second music piece in the high-frequency band within a range from the minimum level H2 min to the preset level H2lv and the volume level of the second music piece in the medium-frequency band within a range from the minimum level M2 min to the preset level M2lv in accordance with the position of the second operator 33B1 as illustrated in FIG. 9 while keeping the volume level of the second music piece in the low-frequency band at the minimum level L2 min (not illustrated in FIG. 9). Specifically, within the first section RB1, the volume adjuster 65 raises the volume levels of the second music piece in the high-frequency and medium-frequency bands when the second operator 3381 is operated in the +DB direction and the volume adjuster 65 lowers the volume levels of the second music piece in the high-frequency and medium-frequency bands when the second operator 33B1 is operated in the −DB direction. The volume of the entire first music piece thus changes. It should be noted that the change rate of the volume level of the second music piece in each of the high-frequency band and the medium-frequency band, which is constant in the example illustrated in FIG. 9, is optionally not constant. For instance, the change rate is optionally changed in accordance with the operation of the second operator 33B1 in the ±DB directions.

When the second operator 33B1 is positioned at the position PB1, the volume adjuster 65 sets the volume level of the second music piece in the high-frequency and medium-frequency bands at the preset levels H2lv and M2lv, respectively, while keeping the volume level of the second music piece in the low-frequency band at the minimum level L2 min.

As described above, the change in the volume of the second music piece when the second operator 33B1 is positioned within the first section RB1 is the same as the change in the volume of the second music piece when the fader operator 51 is positioned within the first section RC1.

### Volume Adjustment in Second Section of Channel Fader

In accordance with the position of the first operator 33A1 in the second section RA2 and the position of the second operator 3381 in the second section RB2, the volume adjuster 65 adjusts the volume level of the first music piece in the low-frequency band within a range from the minimum level L1 min to the preset level L1lv and the volume level of the second music piece in the low-frequency band within a range from the minimum level L2 min to the preset level L2lv.

Specifically, when the first operator 33A1 is positioned within the second section RA2 and the second operator 33B1 is positioned within the second section RB2, the volume adjuster 65 converts the numerical values representing the positions of the first operator 33A1 and the second operator 3381 acquired by the position acquisition unit 63. More specifically, the volume adjuster 65 converts the acquired numerical value representing the position of the first operator 33A1 into a numerical value that is 0 when the first operator 33A1 is positioned at the position PA1 and 1 when the first operator 33A1 is positioned at the second end TA2. Similarly, the volume adjuster 65 converts the acquired numerical value representing the position of the second operator 33B1 into a numerical value that is 0 when the second operator 33B1 is positioned at the position PB1 and 1 when the second operator 3381 is positioned at the second end TB2.

Then, the volume adjuster 65 divides the converted numerical value representing the position of the first operator 33A1 by the converted numerical value representing the position of the second operator 33B1 to acquire a division-result value.

Subsequently, the volume adjuster 65 acquires the volume level of the first music piece and the volume level of the second music piece corresponding to the division result value.

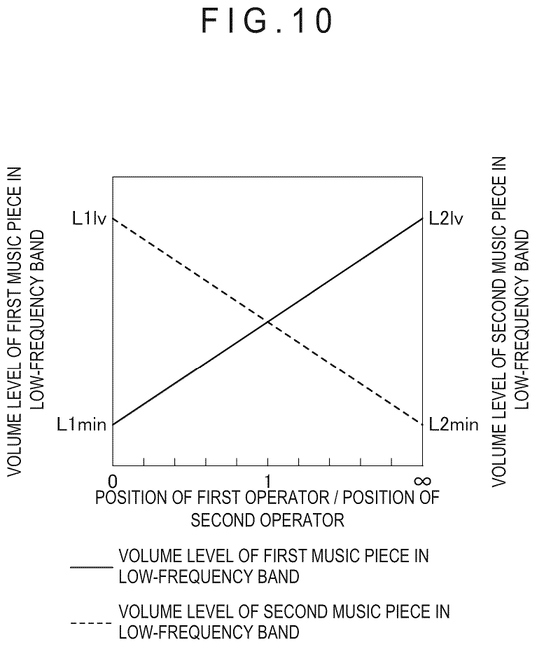

FIG. 10 illustrates an example of the change in the volume level each of the first and second music pieces in the low-frequency band when the first operator 33A1 and the second operator 33B1 are operated in the assist mode. In other words, FIG. 10 illustrates details of level change information stored in the non-illustrated storage.

Herein, the non-illustrated storage stores the graph shown in FIG. 10 in advance. In other words, the storage stores the level change information showing the volume level of each of the music pieces in the low-frequency band corresponding to the division result value. Specifically, the storage stores the level change information showing the volume level of the first music piece in the low-frequency band in a form of a function that comes closer to the minimum level L1 min as the division result value becomes smaller and comes closer to the preset level L1lv as the division result value becomes larger. The storage also stores the level change information showing the volume level of the second music piece in the low-frequency band in a form of a function that comes closer to the preset level L2lv as the division result value becomes smaller and comes closer to the minimum level L2 min as the division result value becomes larger. It should be noted that the function stored as the level change information by the storage is a linear function as shown in FIG. 10 or, alternatively, a higher-order function (e.g. a quadratic function).

Based on the above level change information, the volume adjuster 65 acquires the volume level of each of the music pieces in the low-frequency band and adjusts the volume level of each of the music pieces in the low-frequency band to the acquired volume level.

It should be noted that, when each of the operators 33A1, 33B1 is positioned within the corresponding one of the second sections RA2, RB2, the volume levels of the first music piece in the high-frequency band and the medium-frequency band are respectively the preset levels H11v and M11v and the volume levels of the high-frequency band and the medium-frequency band of the second music piece are respectively the preset levels H2lv and M2lv.

As described above, the change in the volume of each of the music pieces when the first operator 33A1 and the second operator 3381 are respectively positioned within the second section RA2 and the second section RB2 is the same as the change in the volume of each of the music pieces when the fader operator 51 is positioned within the second section RC2.

Switching Outputted Music Piece between First Music Piece and Second Music Piece

When the operation mode of the acoustic control device 1 is the assist mode, the volume adjuster 65 adjusts the volume levels of the first and second music pieces in of each of the frequency bands as described above. Accordingly, the volume of the first music piece in each of the frequency bands can thus be switched with the volume of the second music piece in each of the frequency bands in the same manner as in operating the fader operator 51 by operating the operators 33A1, 3381 as described below.

As an example, it is supposed that the first operator 33A1 is positioned at the second end TA2 and the second operator 33B1 is positioned at the first end TB1. In this case, the volume of the entire first music piece is the first preset volume V1st and the volume of the entire second music piece is the second minimum volume V2 min.

In this state, when the second operator 33B1 is solely operated in the +DB direction, as shown by the volume level of each of the high-frequency band and the medium-frequency band of the second music piece in the graphs on the right side of FIG. 9, the volume level of the second music piece in each of the high-frequency band and the medium-frequency band rises while the volume level of the second music piece in the low-frequency band being kept at the minimum level L2 min during the second operator 3381 being positioned within the first section RB1. Then, when the second operator 33B1 reaches the position PB1, the volume level of the second music piece in the high-frequency band becomes the preset level H2lv and the volume level of the second music piece in the medium-frequency band becomes the preset level M2lv. The volume of the second music piece in each of the high-frequency band and the medium-frequency band can be adjusted in the same manner as in operating the fader operator 51 in the first section RC1.

When the second operator 33B1 is solely operated from the position PB1 in the +DB direction, the volume level of the second music piece in the low-frequency band is raised from the minimum level L2 min and the volume level of the first music piece in the low-frequency band is lowered from the preset level L1lv as illustrated in FIG. 10 while the volume levels of the second music piece in the high-frequency band and the medium-frequency band are kept at the preset levels H2lv, M2lv, respectively. In accordance with the above, the volume of the entire first music piece is lowered from the first preset volume V1st.

Then, when the second operator 3381 reaches the second end TB2, since the first operator 33A1 is also positioned at the second end TA2, the volume level of the second music piece in the low-frequency band becomes equal to the volume level of the first music piece in the low-frequency band as illustrated in FIG. 10.

Subsequently, when the first operator 33A1 is solely operated from the second end TA2 in the −DA direction, the volume level of the first music piece in the low-frequency band is lowered and the volume level of the second music piece in the low-frequency band is raised as illustrated in FIG. 10 while the volume levels of the first music piece in the high-frequency band and the medium-frequency band are kept at the preset levels H1lv, M1lv, respectively.

Then, when the first operator 33A1 reaches the position PA1, the volume level of the first music piece in the low-frequency band becomes the minimum level L1 min and the volume level of the second music piece in the low-frequency band becomes the preset level L2lv. In accordance with the above, the volume of the entire second music piece becomes the second preset volume V2st. In other words, the conditions for the volume of the entire second music piece to be the second preset volume V2st are that the second operator 3381 is positioned at the second end TB2 and the first operator 33A1 is positioned at the position PA, within the first section RA1, or at the first end TA1. The same applies to the conditions for the volume of the entire first music piece to be the first preset volume V1st.

When the first operator 33A1 is operated from the position PA1 in the −DA direction with the second operator 33B1 being positioned at the second end TB2, the volume levels of the first music piece in the high-frequency band and the medium-frequency band are lowered from the preset levels H11v and M11v, respectively, as shown in the graph of the volume level of each of the first music piece in the high-frequency band and the medium-frequency band on the left side of FIG. 9 while the volume level of the first music piece in the low-frequency band is kept at the minimum level L1 min.

Then, when the first operator 33A1 reaches the first end TA1, the volume level of the first music piece in the high-frequency band becomes the minimum level H1 min and the volume level of the second music piece in the medium-frequency band becomes the minimum level M1 min, where the volume of the entire first music piece becomes the first minimum volume V1 min. The respective volume levels of the first music piece in the high-frequency band and the medium-frequency band can thus be adjusted in the same manner as in operating the fader operator 51 in the third section RC3.

As described above, the volume level of the first music piece in the low-frequency band can be lowered and the volume level of the second music piece in the low-frequency band can be raised by operating the second operator 33B1 and the first operator 33A1 within the second section RB2 and the second section RA2, respectively. Specifically, with the volume levels of the first music piece in the high-frequency band and the medium-frequency band being set at the preset levels H1lv, M11v and with the volume levels of the second music piece in the high-frequency band and the medium-frequency band being set at the respective preset levels H2lv, M2lv, the volume of the first music piece in the low-frequency band and the volume of the second music piece in the low-frequency band can be switched by raising or lowering the volume level of each of the first and second music pieces in the low-frequency band.

### Utility of Assist Mode

When the first music piece is to be naturally (i.e. without arousing uncomfortable impression) switched to the second music piece while the operation mode of the acoustic control device 1 is the normal mode, it is sometimes required for a user to operate the low-frequency band adjuster 324 of each of the channel operation units 3A, 3B while operating the fader operator 51 from the first end TC1 in the +DC direction, so as to avoid that the sound of the low-frequency band (e.g. the sound of a base drum) of one of the music pieces is overlapped with the other to be louder than the sound of the other frequency bands. In other words, a plurality of operations are required in order to naturally switch the first music piece to the second music piece in the normal mode without arousing uncomfortable impression. Such operations are difficult for an unaccustomed user (e.g. a beginner), so that it is difficult for the unaccustomed user to naturally switch the music pieces without arousing uncomfortable impression.

In contrast, with the operation mode of the acoustic control device 1 being the assist mode, when the music piece outputted by the acoustic control device 1 is switched from the first music piece to the second music piece, the volume of the first music piece in the low-frequency band and the volume of the second music piece in the low-frequency band can be switched by operating the fader operator 51 or the operators 33A1, 33B1 at a constant speed while keeping the volume of each of the first and second music pieces in each of the high-frequency band and the medium-frequency band. Accordingly, the sounds of the music pieces in the low-frequency band can be restrained from being overlapped to become louder than the sound of the other frequency bands. The above-described unaccustomed user can thus naturally switch the music pieces without arousing uncomfortable impression.

### Advantage(s) of First Exemplary Embodiment

The following advantages can be achieved by the acoustic control device 1 according to the above-described exemplary embodiment.

The acoustic control device 1 mixes the first and second music pieces. When the fader operator 51 is positioned within the second section RC2, the volume adjuster 65 of the acoustic control device 1 lowers the volume level of the first music piece in the low-frequency band and raises the volume level of the second music piece in the low-frequency band in accordance with the operation of the fader operator 51 in the +DC direction, thereby switching the magnitude relationship between the volume of the first music piece in the low-frequency band and the volume of the second music piece in the low-frequency band. The fader operator 51 is an operator for adjusting the volume of the first music piece and the volume of the second music piece.

A computer-readable acoustic control program for allowing a computer to function as the acoustic control device 1 is stored in the storage of the acoustic control device 1. The controller 6 provided with the volume adjuster 65 reads the acoustic control program to control the acoustic control device 1.

According to the above arrangement, since the low-frequency components of the music pieces are switched when the first and second music pieces are mixed, a total volume of the low-frequency components of the first and second music pieces can be kept at the same level as the total volume of the low-frequency components before the first and second music pieces are mixed. The low-frequency components can thus be restrained from being clearly heard during mixing of the first and second music pieces, as compared with an instance where the entire first music piece and the entire second music piece are mixed without adjusting the frequency. Accordingly, the first and second music pieces can be mixed without arousing uncomfortable impression.

The volume adjuster 65 keeps the volume level of each of the first and second music pieces in each of the high-frequency band and the medium-frequency band while the fader operator 51 is operated within the second section RC2 in the +DC direction while lowering the volume level of the first music piece in the low-frequency band and raising the volume level of the second music piece in the low-frequency band.

According to the above arrangement, since the volume of other frequency bands of the music pieces is not changed when the volume of the low-frequency band of each of the music pieces is raised or lowered, the volume of the first music piece in the low-frequency band and the volume of the second music piece in the low-frequency band can be solely switched. Accordingly, low-frequency component of each of the music pieces can be restrained from being more clearly heard than other frequency components. Accordingly, the first and second music pieces can be mixed without arousing uncomfortable impression.

The volume adjuster 65 switches the volume of the first music piece in the low-frequency band and the volume of the second music piece in the low-frequency band while the volume levels of each of the first and second music pieces in the high-frequency band and medium-frequency band are the respective preset levels H1lv, M1lv, H2lv, M1lv (i.e. the preset maximum level).

According to the above arrangement, the low-frequency components of the music pieces can be restrained from being more clearly heard than other frequency components, thereby allowing the music pieces to be mixed without arousing uncomfortable impression.

When the fader operator 51 reaches the middle position of the operable range RC, the volume adjuster 65 equalizes the volume level of the first music piece in the low-frequency band and the volume level of the second music piece in the low-frequency band.

According to the above arrangement, the position for equalizing the volume levels of the low-frequency bands of the first and second music pieces can be intuitively recognized by a user. Accordingly, the operation for adjusting the volume level of each of the music pieces in the low-frequency band can be facilitated.

When the fader operator 51 reaches the second end TC2 of the operable range RC, the volume adjuster 65 sets the volume level of the entirety of the first music piece at the first minimum volume V1 min. The second end TC2 corresponds to “an end” of the operable range RC.

According to the above arrangement, the second music piece can be solely outputted by moving the fader operator 51 to the second end TC2. Accordingly, in addition to being capable of switching from the first music piece to the second music piece, the position for switching the first music piece and the second music piece can be easily recognized by a user.

When the fader operator 51 is operated in the +DC direction, the volume adjuster 65 lowers the volume level of the first music piece in the low-frequency band. The +DC direction corresponds to “a first direction.” When the fader operator 51 is operated in the +DC direction from the position PC3, the volume adjuster 65 lowers the volume level of the first music piece in the high-frequency band and medium-frequency band. The position PC3 is a point at which the volume level of the first music piece in the low-frequency band is at a minimum level in the operable range RC.

According to the above arrangement, when the fader operator 51 is operated in the +DC direction, the volume level of the first music piece in each of the high-frequency band and the medium-frequency band is lowered after the volume level of the first music piece in the low-frequency band is lowered to the minimum level. Accordingly, when the first music piece is to be switched to the second music piece, since the volume of the first music piece in each of the high-frequency and the medium-frequency bands is lowered after the volume of the first music piece in the low-frequency band is switched to the volume of the second music piece in the low-frequency band, the first music piece can be switched to the second music piece without arousing uncomfortable impression.

The volume adjuster 65 includes the cross fader 5 having the slidable fader operator 51. The cross fader 5 is an operator for receiving an operation for adjusting the volume of each of the music pieces.

According to the above arrangement, the first and second music pieces can be mixed by operating the fader operator 51 without arousing uncomfortable impression. Accordingly, as compared with an instance where an operator for controlling the volume of the first music piece and an an operator for controlling the volume of the second music piece are to be operated, the first and second music pieces can be more easily mixed.

The operable range RC of the fader operator 51 includes the first section RC1, the second section RC2, and the third section RC3.

The first section RC1 is a section between the first position PC1 and the second position PC2 located in the +DC direction with respect to the first position PC1.

The second section RC2 is a section between the second position PC2 and the third position PC3 located in the +DC direction with respect to the second position PC2.

The third section RC3 is a section between the third position PC3 and the fourth position PC4 located in the +DC direction with respect to the third position PC3.

The +DC direction (a first operation direction) is a direction oriented from the first end TC1 of the operable range RC to the second end TC2.

When the fader operator 51 is positioned within the first section RC1, the volume adjuster 65 raises the volume level of the second music piece in each of the high-frequency and the medium-frequency bands in accordance with the slide movement of the fader operator 51 in the +DC direction while keeping the volume level of the first music piece in each of the high-frequency, the medium-frequency, and the low-frequency bands at the preset levels H11v, M11v, L11v and keeping the volume level of the second music piece in the low-frequency band at the minimum level L1 min.

When the fader operator 51 is positioned within the second section RC2, the volume adjuster 65 lowers the volume level of the first music piece in the low-frequency band and raises the volume level of the second music piece in the low-frequency band in accordance with the slide movement of the fader operator 51 in the +DC direction while keeping the volume level of the first music piece in each of the high-frequency and the medium-frequency bands and the volume level of the second music piece in each of the high-frequency and medium-frequency bands at the preset levels H1lv, M1lv, H2lv, M2lv, respectively.

It should be noted that each of the preset levels H2lv, M2lv is the maximum level preset for the second music piece in the corresponding one of the high-frequency band and medium-frequency band.

When the fader operator 51 is positioned within the third section RC3, the volume adjuster 65 lowers the volume level of the first music piece in each of the high-frequency and the medium-frequency bands in accordance with the slide movement of the fader operator 51 in the +DC direction while keeping the volume levels of the second music piece in the high-frequency, the medium-frequency, and the low-frequency bands respectively at the preset levels H2lv, M2lv, L2lv and the volume level of the first music piece in the low-frequency band at the minimum level L1 min.

The preset levels H11v, M1v, 11v are the maximum levels respectively preset for the first music piece in the high-frequency band, medium-frequency band, and low-frequency band. The preset levels H2lv, M2lv, L2lv are the maximum levels respectively preset for the second music piece in the high-frequency band, medium-frequency band, and low-frequency band.

According to the above arrangement, when the fader operator 51 is moved from the first end TC1 to the second end TC2, after the volumes of the second music piece in the high-frequency band and the medium-frequency band are raised and the volume of the second music piece in the low-frequency band is switched to the volume of the first music piece in the low-frequency band, the volume of the first music piece in each of the high-frequency band and the medium-frequency band is lowered. Accordingly, the first music piece can be switched to the second music piece without arousing uncomfortable impression.

In the acoustic control device 1, the first position PC1 and the fourth position PC4 are set at the first end TC1 and the second end TC2, respectively. The first section RC1 refers to a section defining one third of the operable range RC from the first end TC1. The second section RC2 refers to a section defining one third of the operable range RC from the second position PC2. The third section RC3 refers to a section defining one third of the operable range RC from the third position PC3.

According to the above arrangement, the first section RC1 for the volumes of the second music piece in the high-frequency band and the medium-frequency band to be adjusted, the second section RC2 for each of the first and second music pieces in the low-frequency band to be adjusted, and the third section RC3 for the first music piece in the high-frequency band and the medium-frequency band to be adjusted can be intuitively recognized by a user. In other words, the range for adjusting the volume of each of the frequency bands of the music pieces can be intuitively recognized by a user. Accordingly, an operation of the fader operator 51 in mixing the first and second music pieces can be facilitated.

### Second Exemplary Embodiment

Next, a second exemplary embodiment of the invention will be described below.

An acoustic control device according to the exemplary embodiment, which is configured in substantially the same manner as the acoustic control device 1 according to the first exemplary embodiment, is different from the acoustic control device 1 according to the first exemplary embodiment in that constituent elements such as a BPM setting unit and a playback control unit are additionally provided. It should be noted that, hereinbelow, the same or substantially the same constituent elements as those having already been described will be denoted by the same reference numerals, omitting description thereof.

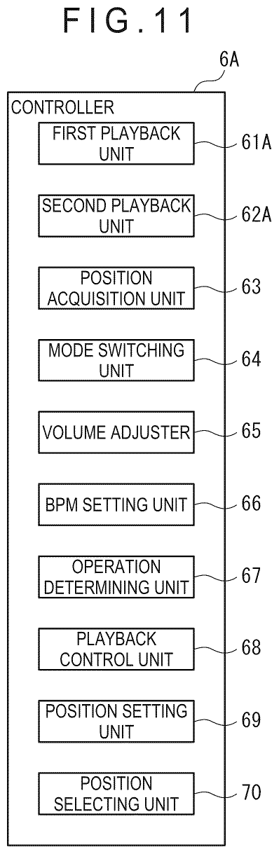

FIG. 11 is a block diagram illustrating a controller 6A of an acoustic control device according to the exemplary embodiment.

The configuration and function of the acoustic control device according to the exemplary embodiment are the same as those of the acoustic control device 1 according to the first exemplary embodiment except that the controller 6A illustrated in FIG. 11 is provided in place of the controller 6 according to the first exemplary embodiment.

As in the controller 6, the controller 6A, which controls the acoustic control device according to the exemplary embodiment, includes a processor (e.g. a CPU (Central Processing Unit)) that reads and executes an acoustic control program stored in a non-illustrated storage. In other words, an arithmetic processor circuit is a computer.

The configuration of the controller 6A is the same as the controller 6 except that the controller 6A includes a first playback unit 61A and a second playback unit 62A in place of the first playback unit 61 and the second playback unit 62 according to the first exemplary embodiment and further includes a BPM setting unit 66, an operation determining unit 67, a playback controller 68, a position setting unit 69, and a position selecting unit 70. In other words, the controller 6A includes the first playback unit 61A, the second playback unit 62A, the position acquisition unit 63, the mode switching unit 64, the volume adjuster 65, the BPM setting unit 66, the operation determining unit 67, the playback controller 68, the position setting unit 69, and the position selecting unit 70.

### Arrangement of First Playback Unit and Second Playback Unit

Similar to the first playback unit 61, the first playback unit 61A plays the first music piece loaded to the first channel. Specifically, when the operation mode of the acoustic control device is the normal mode, the first playback unit 61A plays the first music piece at the playback BPM after being adjusted when the playback BPM of the first music piece are adjusted by the first tempo slider 34A and plays the first music piece at the BPM of the original of the first music piece when the playback BPM of the first music piece are not adjusted.

Similar to the second playback unit 62, the second playback unit 62A plays the second music piece loaded to the second channel. Specifically, when the operation mode of the acoustic control device is the normal mode, the second playback unit 62A plays the second music piece at the playback BPM after being adjusted when the playback BPM of the second music piece is adjusted by the second tempo slider 34B and plays the second music piece at the BPM of the original of the second music piece when the playback BPM of the second music piece are not adjusted.

It should be noted that, when the operation mode of the acoustic control device is the assist mode, the first playback unit 61A and the second playback unit 62A respectively play the first and second music pieces at the respective BPM set by the BPM setting unit 66. In addition, the first playback unit 61A and the second playback unit 62A play the first and second music pieces, respectively, under the control of the playback controller 68.

### Configuration of BPM Setting Unit

The BPM setting unit 66 functions when the operation mode of the acoustic control device is the assist mode. The BPM setting unit 66 sets the playback BPM of each of the first and second music pieces in accordance with the operation of the cross fader 5.

Setting of Playback BPM in Accordance with Operation of Cross Fader

The BPM setting unit 66 sets the playback BPM of each of the music pieces so that the BPM of the first music piece approach the BPM of the second music piece in accordance with the operation of the fader operator 51 in the +DC direction.

The BPM setting unit 66 sets the playback BPM of each of the music pieces so that the BPM of the second music piece approach the BPM of the first music piece in accordance with the operation of the fader operator 51 in the −DC direction.

It should be noted that, when the playback BPM of the first music piece have been adjusted by the first tempo slider 34A, the BPM of the first music piece are the playback BPM adjusted by the first tempo slider 34A. When the playback BPM of the first music piece have not been adjusted by the first tempo slider 34A, the BPM of the first music piece are the BPM of the original of the first music piece.

Similarly, when the playback BPM of the second music piece have been adjusted by the second tempo slider 348, the BPM of the second music piece are the playback BPM adjusted by the second tempo slider 34B. When the playback BPM of the second music piece have not been adjusted by the second tempo slider 348, the BPM of the second music piece are the BPM of the original of the second music piece.

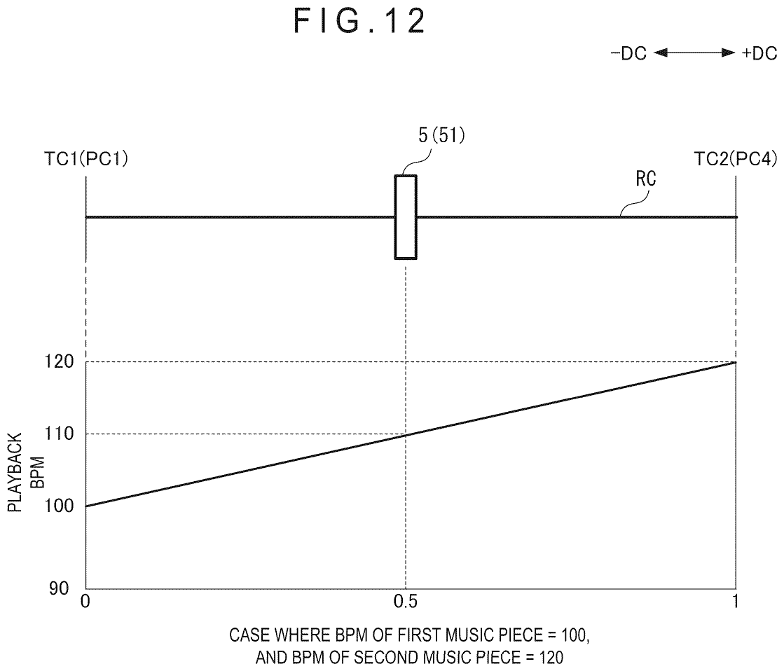

FIG. 12 illustrates an example of a change in the playback BPM of each of the first and second music pieces in the assist mode. Specifically, FIG. 12 illustrates the change in the playback BPM of each of the first and second music pieces when the cross fader 5 is operated in the assist mode, where the BPM of the first music piece are 100 and the BPM of the second music piece are 120. It should be noted that a numerical value showing the relative position of the above-described fader operator 51 is plotted on the abscissa axis of the graph illustrated in FIG. 12.

As illustrated in FIG. 12, the BPM setting unit 66 adjusts the playback BPM of each of the first and second music pieces in accordance with the position of the fader operator 51.

Specifically, the BPM setting unit 66 sets the playback BPM of each of the music pieces so that the BPM of the first music piece approach the BPM of the second music piece in accordance with the operation of the fader operator 51 in the +DC direction oriented from the first end TC1 to the second end TC2.

Then, when the fader operator 51 is positioned at the second end TC2 (the fourth position PC4), the BPM setting unit 66 sets the playback BPM of each of the music pieces at the BPM of the second music piece. In the example illustrated in FIG. 12, the playback BPM of each of the music pieces are set at 120.

The BPM setting unit 66 sets the playback BPM of each of the music pieces so that the BPM of the second music piece approach the BPM of the first music piece as the fader operator 51 is operated in the −DC direction oriented from the second 25 end TC2 to the first end TC1.

Then, when the fader operator 51 is positioned at the first end TC1 (the first position PC1), the BPM setting unit 66 sets the playback BPM of each of the music pieces at the BPM of the first music piece. In the example illustrated in FIG. 12, the playback BPM of each of the music pieces are set at 100 (i.e. the BPM of the first music piece).

Then, when the fader operator 51 is positioned at the middle position of the operable range RC, the BPM setting unit 66 sets the playback BPM of each of the music pieces at a middle value of the BPM of the first and second music pieces.

The change rate of the playback BPM when the fader operator 51 is operated in the ±DC directions, which is constant in the example illustrated in FIG. 12, is optionally not constant. For instance, the change rate is optionally changed in accordance with the operation of the fader operator 51 in the ±DC directions.

The playback BPM of the music pieces to be mixed can thus be easily equalized in accordance with the operation of the fader operator 51. Accordingly, the music pieces can be naturally mixed without arousing uncomfortable impression.

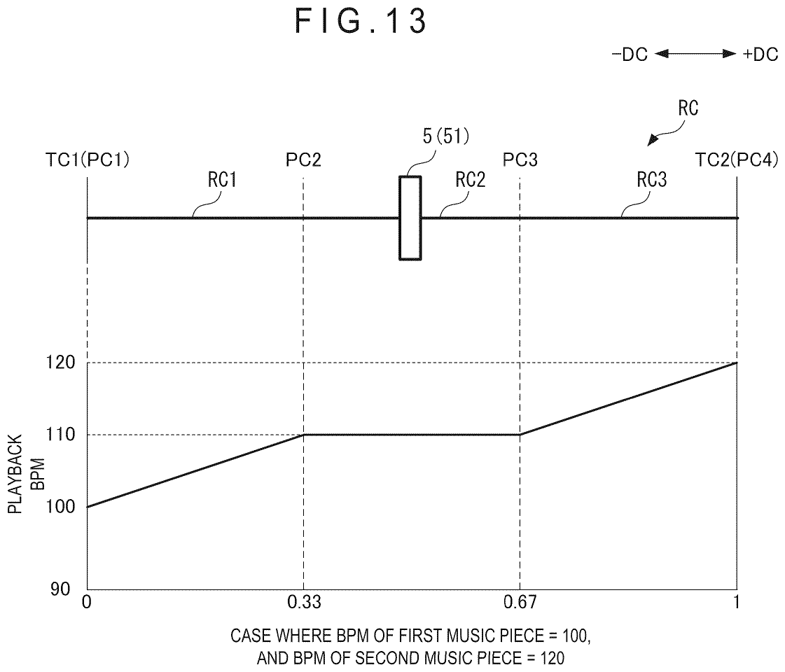

FIG. 13 illustrates another example of a change in the playback BPM of each of the first and second music pieces in the assist mode. Specifically, FIG. 13 illustrates the change in the playback BPM of each of the first and second music pieces when the cross fader 5 is operated in the assist mode, where the BPM of the first music piece are 100 and the BPM of the second music piece are 120. It should be noted that a numerical value showing the relative position of the above-described fader operator 51 is plotted on the abscissa axis of the graph shown in FIG. 13.

It should also be noted that the change in the playback BPM when the fader operator 51 is operated is optionally not constant all over the operable range RC. For instance, the BPM setting unit 66 optionally adjusts the playback BPM of the first and second music pieces in accordance with the position of the fader operator 51 when the fader operator 51 is positioned within the first section RC1 and the third section RC3, as illustrated in FIG. 13.

In this case, when the fader operator 51 is positioned at the first end TC1 (the first position PC1), the BPM setting unit 66 sets the playback BPM of each of the first and second music pieces at the BPM of the first music piece. In the example illustrated in FIG. 12, the playback BPM of each of the music pieces are set at 100 (i.e. the BPM of the first music piece).

When the fader operator 51 is positioned within the first section RC1, the BPM setting unit 66 sets the playback BPM of each of the music pieces in accordance with the position of the fader operator 51 within the range from the BPM of the first music piece to the middle value of the BPM of the first and second music pieces. In the example illustrated in FIG. 12, where the BPM of the first music piece are 100 and the middle value of the BPM of the first and second music pieces is 110, the playback BPM of each of the music pieces are set at a value larger than 100 and less than 110 when the fader operator 51 is positioned within the first section RC1.

When the fader operator 51 is positioned at the second position PC2, within the second section RC2, or at the third position PC3, the BPM setting unit 66 sets the playback BPM of each of the first and second music pieces at the above-described middle value. In the example illustrated in FIG. 13, the playback BPM of each of the music pieces are set at 110.

When the fader operator 51 is positioned within the third section RC3, the BPM setting unit 66 sets the playback BPM of each of the first and second music pieces in accordance with the position of the fader operator 51 within the range from the middle value of the BPM of the first and second music pieces to the BPM of the second music piece. In the example illustrated in FIG. 13, where the BPM of the second music piece are 120, the playback BPM of each of the music pieces are set at a value larger than 110 and less than 120.

When the fader operator 51 is positioned at the second end TC2 (the fourth position PC4), the BPM setting unit 66 sets the playback BPM of each of the first and second music pieces at the BPM of the second music piece. In the example illustrated in FIG. 13, the playback BPM of each of the music pieces are set at 120.

The change rate of the playback BPM within the first and third sections RC1 and RC3, which is constant in the example illustrated in FIG. 13, is optionally not constant. For instance, the change rate is optionally changed in accordance with the operation of the fader operator 51 in the ±DC directions.

With the playback BPM of each of the music pieces being changed as described above, the playback BPM of each of the music pieces can be adjusted by the BPM setting unit 66 in line with the volume level adjustment in the high-frequency band and the medium-frequency band by the volume adjuster 65 in accordance with the operation of the fader operator 51. Accordingly, the music pieces can be naturally mixed without arousing uncomfortable impression.

Setting of Playback BPM in Accordance with Operation of Channel Fader

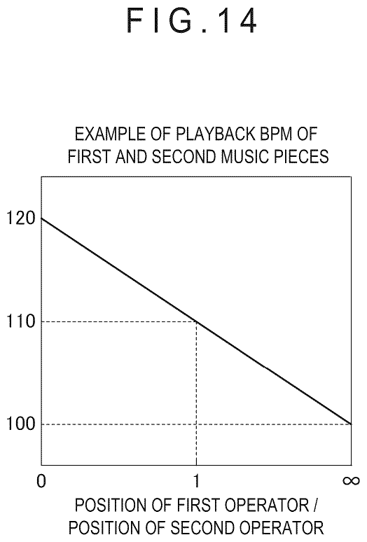

FIG. 14 illustrates an example of a change in the playback BPM of each of the first and second music pieces in the assist mode. Specifically, FIG. 14 illustrates the change in the playback BPM of each of the music pieces when the first and second operators 33A1 and 33B1 are operated in the assist mode, where the BPM of the first music piece are 100 and the BPM of the second music piece are 120. It should be noted that a numerical value showing the relative position of the above-described fader operator 51 is plotted on the abscissa axis of the graph shown in FIG. 14.

As illustrated in FIG. 14, the BPM setting unit 66 sets the playback BPM of each of the first and second music pieces in accordance with a user's operation of the first operator 33A1 of the first channel fader 33A and the second operator 3381 of the second channel fader 33B.

In the exemplary embodiment, the graph shown in FIG. 14 is stored in the non-illustrated storage in advance. Specifically, the storage stores the BPM change information showing the playback BPM corresponding to the numerical value of the result of division, or the division result value, of the numerical value representing the position of the first operator 33A1 by the numerical value representing the position of the second operator 3381. As described above, the numerical value representing the position of the first operator 33A1 is in a range from 0 to 1 and the numerical value representing the position of the second operator 3381 is in a range from 0 to 1.

Specifically, the storage stores the BPM change information in a form of a function whose value approaches the BPM of the second music piece as the division result value becomes smaller and approaches the BPM of the first music piece as the division result value becomes larger. It should be noted that the function stored as the BPM change information by the storage is a linear function as illustrated in FIG. 14 or, alternatively, a higher-order function (e.g. a quadratic function).

It should also be noted that the non-illustrated storage optionally stores, in place of the above-described BPM change information, the BPM change information representing the playback BPM corresponding to the numerical value of the result of division of the volume of the entire first music piece by the volume of the entire second music piece. As described above, the entire volumes of the first and second music pieces are set in accordance with the position of the first operator 33A1 and the position of the second operator 33B1, respectively.

The BPM setting unit 66 acquires the above-described division result value based on the position of each of the operators 33A1, 33B1 or the entire volume of each of the music pieces to acquire the playback BPM corresponding to the division result value based on the BPM change information.

The BPM setting unit 66 sets the playback BPM of each of the first and second music pieces at the acquired playback BPM. The playback BPM of the music pieces are thus equalized.

Based on the BPM change information, when the first operator 33A1 is positioned at the first end TA1 and the second operator 3381 is positioned at the second end TB2, the BPM setting unit 66 sets the playback BPM of each of the first and second music pieces at the BPM of the second music piece. In the example illustrated in FIG. 14, the playback BPM of each of the music pieces are set at 120. When the operators 33A1, 3381 are positioned as described above, the volume of the entire first music piece is the first minimum volume V1 min and the volume of the entire second music piece is the second maximum volume V2max.

When at least one of the operation of the first operator 33A1 from the first end TA1 in the +DA direction or the operation of the second operator 3381 from the second end TB2 in the −DB direction is made, the BPM setting unit 66 brings the playback BPM of each of the music pieces close to the BPM of the first music piece from the BPM of the second music piece.

In contrast, when the first operator 33A1 is positioned at the second end TA2 and the second operator 3381 is positioned at the first end TB1, the BPM setting unit 66 sets the playback BPM of each of the first and second music pieces at the BPM of the first music piece. In the example illustrated in FIG. 14, the playback BPM of each of the music pieces are set at 100. The above positions of the operators 33A1, 3381 satisfy the conditions for setting the volume of the entire first music piece at the first preset volume V1st and setting the volume of the entire second music piece at the second minimum volume V2 min.

When at least one of the operation of the first operator 33A1 from the second end TA2 in the −DA direction or the operation of the second operator 33B1 from the first end TB1 in the +DB direction is made, the BPM setting unit 66 brings the playback BPM of each of the music pieces close to the BPM of the second music piece from the BPM of the first music piece.

According to the above arrangement, in the process for the volume adjuster 65 to switch the outputted music piece from the first music piece to the second music piece by, for instance, operating the second operator 33B1 from the first end TB1 to the second end TB2 while the first operator 33A1 is positioned at the second end TA2 and, subsequently, operating the first operator 33A1 from the second end TA2 to the first end TA1, the BPM setting unit 66 can bring the playback BPM of the second music piece close to the BPM of the second music piece from the BPM of the first music piece in line with the increase in the volume of the second music piece and simultaneously bring the playback BPM of the first music piece close to the BPM of the second music piece from the BPM of the first music piece in line with the decrease in the volume of the first music piece. Accordingly, when the ratio of the volume of the first music piece in the volume outputted by the acoustic control device is larger than the ratio of the volume of the second music piece, the music pieces can be played at the playback BPM closer to the BPM of the first music piece as compared with the BPM of the second music piece. Accordingly, when the ratio of the volume of the second music piece in the volume outputted by the acoustic control device is larger than the ratio of the volume of the first music piece, the music pieces can be played at a playback BPM closer to the BPM of the second music piece as compared with the BPM of the first music piece. The music pieces can thus be mixed at equalized playback BPM without manually adjusting the playback BPM of each of the music pieces.

### Configuration of Operation Determining Unit and Playback Control Unit

The operation determining unit 67 and the playback controller 68 illustrated in FIG. 11 function when the operation mode of the acoustic control device is the assist mode.

The operation determining unit 67 determines the operation of the fader operator 51. Specifically, the operation determining unit 67 determines whether the speed of the fader operator 51 when the fader operator 51 is operated from one of the first and second ends TC1, TC2 to reach the other end is a predetermined value or more. Specifically, the operation determining unit 67 determines whether the speed of the fader operator 51 when the fader operator 51 is operated from one of the first and second ends TC1, TC2 to reach the other end is less than a predetermined time.

The playback controller 68 controls a playback state of the first music piece by the first playback unit 61A and a playback state of the second music piece by the second playback unit 62A in accordance with the operation of the fader operator 51 of the cross fader 5. Specifically, the playback controller 68 controls the playback position of each of the first and second music pieces based on the determination result of the operation determining unit 67.

The playback controller 68 performs a first playback control process described below when the speed of the fader operator 51 upon being moved from one of the first and second ends TC1, TC2 to the other end is a predetermined value or more, and performs a second playback control process described below when the speed of the fader operator 51 is less than the predetermined value.

In other words, the playback controller 68 performs the first playback control process described below when a time for the fader operator 51 to be moved from the one of the first and second ends TC1, TC2 to the other end is a predetermined time or more and performs the second playback control process described below when the time is less than the predetermined time.

Specifically, the playback controller 68 performs the second playback control process described below when the fader operator 51 moved away from the one of the first and second ends TC1, TC2 reaches the other end in less than the predetermined time and performs the first playback control process described below when the the fader operator 51 does not reach the other end after the predetermined time elapses.

It should be noted that, in both of the playback control processes, when the fader operator 51 is positioned at the first end TC1 or the second end TC2, the playback controller 68 does not control the playback process of the first and second music pieces by the first playback unit 61A and the second playback unit 62A, respectively.

### First Playback Control Process

The first playback control process is performed when the fader operator 51 is slowly operated from one of the first and second ends TC1, TC2 to the other end. In the following description, it is supposed that the fader operator 51 is operated from the first end TC1 to the second end TC2.

When the fader operator 51 is operated from the first end TC1 in the +DC direction, the playback controller 68 shifts the playback positions of the first and second music pieces to predetermined first and third playback positions, respectively. It should be noted that, when the second music piece is suspended from being played by the second playback unit 62A, the playback controller 68 commands the second playback unit 62A to start playing the second music piece.

When the playback position of the first music piece is shifted to the first playback position, the playback controller 68 plays the first music piece in loop between the first playback position and a predetermined second playback position that is a playback position after the first playback position. When the playback position of the second music piece is shifted to the third playback position, the playback controller 68 plays the second music piece in loop between the third playback position and a predetermined fourth playback position that is a playback position after the third playback position. In other words, the playback position of the second music piece when the fader operator 51 is operated from the first end TC1 in the +DC direction is the third playback position, which is located before the fourth playback position.

When the fader operator 51 reaches the second end TC2, the playback controller 68 cancels the loop playback of the first and second music pieces by the first playback unit 61A and the second playback unit 62A, respectively.

The second music piece can thus be played from the fourth playback position simultaneously with switching the first music piece to the second music piece.

### Specific Example of First Playback Control Process

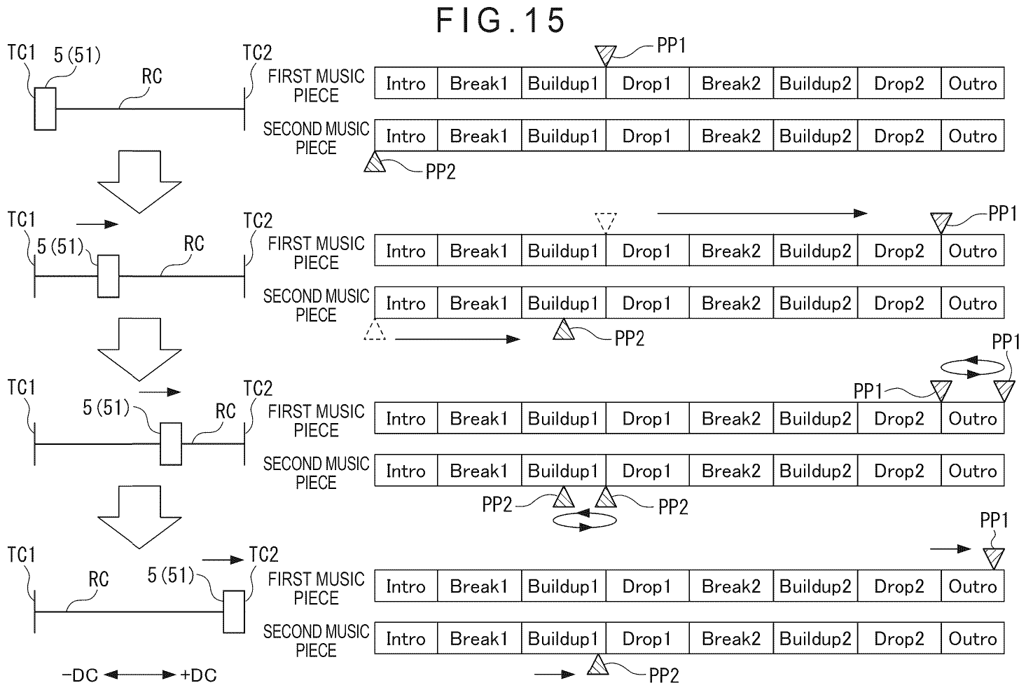

FIG. 15 illustrates an example of the first playback control process by the playback controller 68. It should be noted that “Breakdown” is illustrated as “Break” in FIG. 15.

A specific example of the first playback control process will be described below with reference to FIG. 14.

In the example illustrated in FIG. 15, each of the first and second music pieces is a music piece in a form of a series of music constituent elements consisting of intro (Intro), breakdown 1 (Break 1), buildup 1 (Buildup 1), drop 1 (Drop 1), breakdown 2 (Breakdown2), buildup 2 (Buildup2), drop 2 (Drop2), and ending (Outro) arranged in this order. In the example illustrated in FIG. 15, the first playback position of the first music piece is set at a start position of ending and the second playback position of the first music piece is set at an end position of ending (i.e. the end position of the first music piece). In the example illustrated in FIG. 15, the third playback position of the second music piece is set at an intermediate position in buildup 1 and the fourth playback position of the second music piece is set at a start position of drop 1.

When, for instance, as illustrated in the first row from the top in FIG. 15, the fader operator 51 is positioned at the first end TC1, the playback controller 68 does not control the playback process of the first and second music pieces by the first playback unit 61A and the second playback unit 62A, respectively. Accordingly, the first music piece is played at the BPM of the first music piece by the first playback unit 61A.

As illustrated in the second row from the top in FIG. 15, when the fader operator 51 is operated from the first end TC1 in the +DC direction, the playback controller 68 shifts the playback position PP1 of the first music piece to the start position of ending (the first playback position) and shifts the playback position PP2 of the second music piece to the intermediate position in buildup 1 (the third playback position). When the second music piece is suspended from being played, the playback controller 68 commands the second playback unit 62A to start playing the second music piece, as described above.

As illustrated in the third row from the top of FIG. 15, when the playback position PP1 of the first music piece is shifted to the start position of ending of the first music piece, the playback controller 68 commands the first playback unit 61A to repeatedly play a part of the music piece between the start position of ending of the first music piece and the end position of ending (the second playback position). Simultaneously, when the playback position PP2 of the second music piece is shifted to the intermediate position in buildup 1, the playback controller 68 commands the second playback unit 62A to repeatedly play a part of the music piece between the intermediate position of buildup 1 of the second music piece and the position of drop 1 (the fourth playback position).

When the fader operator 51 is positioned at the second end TC2 as illustrated in the fourth row from the top in FIG. 15, the playback controller 68 cancels the repeat playback of the first and second music pieces. The playback of the first music piece being played by the first playback unit 61A is thus stopped in accordance with stopping playing the ending of the first music piece. In contrast, the playback of the second music piece is continued by the second playback unit 62A, where drop 1 of the second music piece is played some time later. As described above, when the fader operator 51 is positioned at the second end TC2, the volume adjuster 65 sets the volume of the entire first music piece at the first minimum volume V1 min and the volume of the entire second music piece at the second preset volume V2st. Further, the BPM setting unit 66 sets the playback BPM of each of the music pieces at the BPM of the second music piece.

In the above, an instance where the fader operator 51 is operated from the first end TC1 to the second end TC2 is described. It should however be noted that the same applies to an instance where the fader operator 51 is operated from the second end TC2 to the first end TC1.

Specifically, when the fader operator 51 is operated from the second end TC2 in the −DC direction, the playback position PP2 is shifted to the first playback position of the second music piece, where a part of the music piece between the first playback position and the second playback position is repeatedly played, and the playback position PP1 is shifted to the third playback position of the first music piece, where a part of the music piece between the third playback position and the fourth playback position is repeatedly played. Then, when the fader operator 51 is positioned at the first end TC1, the repeat playback of each of the music pieces is cancelled by the playback controller 68.

As described above, the playback position of the first music piece and the playback position of the second music piece are controlled in accordance with the operation of the fader operator 51 from the first end TC1 or the second end TC2, so that the first and second music pieces can be naturally mixed.

### Playback of Music Piece at the Time When Reaching an End

In the above, it is supposed that the playback controller 68 cancels the repeat playback of a part of the second music piece between the third playback position and the fourth playback position when the fader operator 51 is operated in the +DC direction to reach the second end TC2. In other words, the second music piece, whose repeat playback is cancelled, is continued to be played from the playback position when the fader operator 51 reaches the second end TC2. However, the playback controller 68 optionally performs one of the following first and second patterns.

In the first pattern, the playback position PP2 of the second music piece is shifted to the fourth playback position at the timing when the fader operator 51 reaches the second end TC2. In the example illustrated in FIG. 14, drop 1 of the second music piece is played at the timing when the volume of the entire first music piece becomes the first minimum volume V1 min. Accordingly, the first music piece can be naturally switched to the second music piece.

In the second pattern, the playback position PP2 of the second music piece is shifted to the fourth playback position at the timing of completing the playback of a currently played measure, when the playback position PP2 of the second music piece has not reached a point for delimiting the measures at the timing for the fader operator 51 to reach the second end TC2. In the example illustrated in FIG. 14, the playback position PP2 of the second music piece is shifted to drop 1 at the point for delimiting the measures, so that the music pieces can be naturally mixed without causing abrupt change in construction.

### Second Playback Control Process

The second playback control process is performed when the fader operator 51 is rapidly operated from one of the first and second ends TC1, TC2 to the other end. Specifically, in the second playback control process, the playback position of the second music piece is shifted to the fourth playback position of the second music piece when the fader operator 51 is rapidly operated from the first end TC1 to the second end TC2, and the playback position of the first music piece is shifted to the fourth playback position of the first music piece when the fader operator 51 is rapidly operated from the second end TC2 to the first end TC1. In this case, since the volume of the entire first music piece is set at the first minimum volume V1 min by the volume adjuster 65, the first music piece is not outputted.

When the second music piece as illustrated in FIG. 14 is played by the second playback unit 62A and the second playback control process is performed by the playback controller 68, the playback position of the second music piece is shifted to the start position of drop 1 without the playback position of the first music piece being changed. It should be noted that, when the second music piece is suspended from being played by the second playback unit 62A, the playback controller 68 commands the second playback unit 62A to start playing the second music piece.

According to the above-described second playback control process, a chorus part of the second music piece can be instantaneously played when the first music piece is switched to the second music piece.

### Configuration of Position Setting Unit and Position Selecting Unit

The position setting unit 69 illustrated in FIG. 11 sets points available for the first playback position, the second playback position, the third playback position, and the fourth playback position on each of the music pieces in accordance with a user's operation. Examples of such points include cue points. Examples of such points also include a start position of each of the music constituent elements of the music piece. It should be noted that examples of the music constituent elements include intro, drop, ending, and the like, as described above.

The position selecting unit 70 functions when the operation mode of the acoustic control device is the assist mode. The position selecting unit 70 selects the first playback position, the second playback position, the third playback position, and the fourth playback position of each of the music pieces from among the points set by the position setting unit 69 in accordance with a user's operation. The playback positions selected by the position selecting unit 70 are used in the above-described first and second playback control processes by the playback controller 68.

The playback positions can be set and selected at positions desired by a user by the above position setting unit 69 and the position selecting unit 70.

### Advantage(s) of Second Exemplary Embodiment

In addition to the advantages achieved by the acoustic control device according to the first exemplary embodiment, the following advantages can be achieved by the acoustic control device according to the above-described exemplary embodiment.

The controller 6A of the acoustic control device according to the exemplary embodiment includes the BPM setting unit 66. When the BPM of the first music piece are different from the BPM of the second music piece, with the volume of the entire first music piece being the first preset volume V1st and the volume of the second music piece being the second minimum volume V2 min, the BPM setting unit 66 sets the playback BPM of the second music piece at the BPM of the first music piece. The BPM setting unit 66 brings the playback BPM of the second music piece close to the BPM of the second music piece in accordance with the operation of the fader operator 51 in a direction for lowering the volume of the first music piece and for raising the volume of the second music piece. Further, the BPM setting unit 66 brings the playback BPM of the first music piece close to the BPM of the second music piece from the BPM of the first music piece in accordance with the operation of the first operator 33A1 in the direction for lowering the volume of the volume of the first music piece and brings the playback BPM of the second music piece close to the BPM of the second music piece from the BPM of the first music piece in accordance with the operation of the second operator 3381 in the direction for raising the second music piece. The first preset volume V1st is the maximum value preset for the volume of the first music piece. The second minimum volume V2 min is the minimum value of the volume of the entire second music piece.

According to the above arrangement, as the ratio of the volume of the second music piece in the volume outputted by the acoustic control device becomes larger than the ratio of the volume of the first music piece, the playback BPM of the second music piece approach the BPM of the second music piece from the BPM of the first music piece. Accordingly, the playback BPM of the music pieces can be equalized in accordance with the volume balance between the first and second music pieces. In other words, since the music pieces are played at the BPM close to the BPM of one of the music pieces whose volume ratio in the outputted volume is larger, uncomfortable impression aroused when the first and second music pieces with large difference in BPM are mixed can be reduced. Accordingly, the first music piece can be switched to the second music piece without arousing uncomfortable impression.

When the volume of the entire first music piece is the first minimum volume V1 min and the volume of the entire second music piece is the second preset volume V2st in the operable range RC, the BPM setting unit 66 of the acoustic control device according to the exemplary embodiment equalizes the playback BPM of the second music piece and the BPM of the second music piece. Specifically, when the fader operator 51 is positioned at the second end TC2, the BPM setting unit 66 sets the playback BPM of the second music piece at the BPM of the second music piece. The second preset volume V2st is the maximum value preset for the volume of the second music piece. The first minimum volume V1 min is the minimum value of the volume of the entire first music piece.

According to the above arrangement, the playback BPM of the second music piece become the BPM set for the second music piece at the timing when the process for switching the first music piece to the second music piece is completed. Accordingly, the second music piece can be played at the BPM set for the second music piece.

### Modification of Embodiments

It should be noted that the invention is not limited to the above-described exemplary embodiments but includes modifications, improvements, and the like as long as an object of the invention can be achieved.

In the above exemplary embodiments, the operators for adjusting the volume of the first and second music pieces are the fader operator 51 of the cross fader 5, the first operator 33A1 of the first channel fader 33A, and the second operator 33B1 of the second channel fader 33B. However, the operator(s) for simultaneously or independently adjusting the volume of each of the first and second music pieces, which is optionally not a slidable operator, is optionally an operation knob rotatable around a rotation axis. In other words, the operator of the invention is optionally an operator of a different type.

The acoustic control device of the invention is optionally provided with the assist mode as a sole operation mode. The acoustic control device of the invention optionally includes a plurality of operators, one of the plurality of operators being operated to allow the volume adjuster 65 to function in the normal mode and other one of the plurality of operators being operated to allow the volume adjuster 65 to function in the assist mode.

According to the above exemplary embodiments, in the second section RC2 where the volume of each of the first and second music pieces is adjusted in the assist mode, the volume levels of the first music piece in the high-frequency band, the medium-frequency band of the first music piece, the high-frequency band of the second music piece, and the second music piece in the medium-frequency band are respectively kept at the preset levels H11v, M11v, H2lv, and M2lv. However, the volume levels of the first music piece in the high-frequency band, the medium-frequency band of the first music piece and the second music piece in the high-frequency band of the second music piece, and the medium-frequency band are not necessarily set as in the exemplary embodiments but are optionally kept at a predetermined volume level(s). Alternatively, when, for instance, the fader operator 51 is operated in the +DC direction, the volume level of the second music piece in the low-frequency band optionally starts to be raised before the volume levels of the second music piece of the high-frequency band and medium-frequency band respectively reach the preset levels H2lv, M2lv. In addition, the volume levels of the first music piece in the high-frequency band and the medium-frequency band optionally start to be lowered before the volume level of the first music piece in the low-frequency band reaches the minimum level L1 min. The same applies to an instance where the first operator 33A1 and the second operator 33B1 are operated.

In the above exemplary embodiments, the volume level of the first music piece in the low-frequency band and the volume level of the second music piece in the low-frequency band are equalized when the fader operator 51 is positioned at the middle position of the operable range RC. However, the position of the fader operator 51 when the volume level of the first music piece in the low-frequency band and the volume level of the second music piece in the low-frequency band are equalized is not necessarily defined at the middle position of the operable range RC such as described above.

In the above exemplary embodiments, the volume of the entire second music piece is set at the second minimum volume V2 min when the fader operator 51 reaches the first end TC1 of the operable range RC, and the volume of the entire first music piece is set at the first minimum volume V1 min when the fader operator 51 reaches the second end TC2. However, the position of the fader operator 51 for the volume of the entire first music piece to be the first minimum volume V1 min when the fader operator 51 is operated in the +DC direction is optionally not the second end TC2 but is optionally a position located in the −DC direction with respect to the second end TC2. Similarly, the position of the fader operator 51 for the volume of the entire second music piece to be the second minimum volume V2 min when the fader operator 51 is operated in the −DC direction is optionally not the first end TC1 but is optionally a position located in the +DC direction with respect to the first end TC1.

Further, the volume of the entire second music piece is optionally not set at the second minimum volume V2 min when the fader operator 51 reaches the first end TC1 of the operable range RC and the volume of the entire first music piece is optionally not set at the first minimum volume V1 min when the fader operator 51 reaches the second end TC2.

The same applies an instance where the first operator 33A1 and the second operator 33B1 are respectively operated to the first ends TA1, TB1 and the second ends TA2, TB2.

In the above exemplary embodiments, the volume level of each of the first music piece in the high-frequency band and medium-frequency band is lowered when the fader operator 51 is operated further in the +DC direction from the third position PC3 where the volume level of the first music piece in the low-frequency band becomes the minimum level H1 min. However, not only the volume level of the first music piece in the low-frequency band but also the volume level of the first music piece in each of the high-frequency band and the medium-frequency band is optionally lowered when the fader operator 51 is operated in the +DC direction from a position located in the −DC direction with respect to the third position PC3 as described above. The same applies to the volume level of the second music piece. The same also applies an instance where the first operator 33A1 and the second operator 33B1 are operated.

In the above exemplary embodiments, the operable range RC includes the first section RC1, the second section RC2, and the third section RC3. In the first section RC1, the volume adjuster 65 raises the volume level of the second music piece in each of the high-frequency and the medium-frequency bands in accordance with the operation of the fader operator 51 in the +DC direction while the volume levels of the first music piece in the high-frequency, the medium-frequency, and the low-frequency bands are respectively at the preset levels H11v, M11v, L1lv and the volume level of the second music piece in the low-frequency band is at the minimum level L2 min. In the second section RC2, the volume adjuster 65 lowers the volume level of the first music piece in the low-frequency band and raises the volume level of the second music piece in the low-frequency band in accordance with the operation of the fader operator 51 in the +DC direction while keeping the volume levels of the music pieces in the high-frequency and medium-frequency bands are respectively at the preset levels H1lv, M1lv, H2lv, M2lv. In the third section RC3, the volume adjuster 65 lowers the volume level of the first music piece in each of the high-frequency and the medium-frequency bands in accordance with the operation of the fader operator 51 in the +DC direction while the volume levels of the second music piece in the high-frequency, the medium-frequency, and the low-frequency bands are respectively at the preset levels H2lv, M2lv, L2lv and the volume level of the first music piece in the low-frequency band is at the minimum level L2 min. It should be noted that each of the preset levels H1lv, M1lv, L11v, H2lv, M2lv, L2lv is the maximum level preset for the corresponding one of the frequency bands.

However, for instance, a part of the first section RC1 and a part of the second section RC2 are optionally mutually overlapped, or alternatively, a part of the second section RC2 and a part of the third section RC3 are optionally mutually overlapped.

In addition, the operable range RC is optionally segmented into more number of sections. For instance, the range for raising/lowering the volume of the first music piece in the high-frequency band and the range for raising/lowering the volume of the first music piece in the medium-frequency band are optionally independently provided. Similarly, the section for raising/lowering the volume of the second music piece in the high-frequency band and the section for raising/lowering the volume of the second music piece in the medium-frequency band are optionally independently provided.

In the above exemplary embodiments, the first section RC1 refers to a section defining one third of the operable range RC from the first end TC1, the second section RC2 refers to a section defining one third of the operable range RC from the second position PC2, and the third section RC3 refers to a section defining one third of the operable range RC from the third position PC3. In other words, the sections RC1 to RC3 are defined as sections equally segmented in the operable range RC. However, the sections are not necessarily defined as the above: one of the first section RC1, the second section RC2, and the third section RC3 is optionally larger than the other sections.

In the above exemplary embodiments, the acoustic control program read and run by the arithmetic processor circuit (computer) is stored in the non-illustrated storage. However, the acoustic control program, which is not necessarily arranged as in the above, is optionally recorded in a recording medium in a manner readable by a computer and is optionally read from the recording medium and executed at the time of operating the acoustic control device 1.

Alternatively, the acoustic control program is optionally provided from a provider device (e.g. a server) through a network (e.g. the Internet).

### SUMMARY OF THE INVENTION

Summary of the invention will be described below.

[1] An acoustic control device is configured to mix a first music piece and a second music piece, in which
in accordance with an operation of an operator configured to adjust a volume of the first music piece and a volume of the second music piece,
a magnitude relationship between a volume of the first music piece in a low-frequency band and a volume of the second music piece in a low-frequency band is switched by lowering a volume level of the first music piece in the low-frequency band and raising a volume level of the second music piece in the low-frequency band.

According to the above arrangement, since the low-frequency components of the respective music pieces are switched when the first and second music pieces are mixed, a total volume of the low-frequency components of the first and second music pieces can be kept at the same level as the total volume of the low-frequency components before the first and second music pieces are mixed. The low-frequency components can thus be restrained from being clearly heard during mixing of the first and second music pieces, as compared with an instance where the entire first music piece and the entire second music piece are mixed without adjusting the frequency. Accordingly, the first and second music pieces can be mixed without arousing uncomfortable impression.

[2] In the acoustic control device according to [1],
while the volume level of the first music piece in the low-frequency band is lowered and the volume level of the second music piece in the low-frequency band is raised, a volume level of the first music piece in each of a high-frequency band and a medium-frequency band and a volume level of the second music piece in each of a high-frequency band and a medium-frequency band are kept.

According to the above arrangement, since the volume level of other frequency bands of the music pieces is not changed when the volume level of the low-frequency band of each of the music pieces is raised or lowered, the volume of the first music piece in the low-frequency band and the volume of the second music piece in the low-frequency band can be solely switched. Accordingly, the low-frequency component of each of the music pieces can be restrained from being more clearly heard than other frequency components. Accordingly, the first and second music pieces can be mixed without arousing uncomfortable impression.

[3] In the acoustic control device according to [1] or [2],
the volume of the first music piece in the low-frequency band and the volume of the second music piece in the low-frequency band are switched while a volume level of the first music piece in each of a high-frequency band and a medium-frequency band and a volume level of the second music piece in each of a high-frequency band and a medium-frequency band are at a preset maximum level.

According to the above arrangement, the low-frequency components of the music pieces can be restrained from being more clearly heard than other frequency components, thereby allowing the music pieces to be mixed without arousing uncomfortable impression.

[4] In the acoustic control device according to any one of claims [1] to [3], when the operator reaches a middle position of an operable range of the operator, the volume level of the first music piece in the low-frequency band and the volume level of the second music piece in the low-frequency band are equalized.

According to the above arrangement, the position for equalizing the volume levels of the low-frequency bands of the first and second music pieces can be intuitively recognized by a user. Accordingly, the operation for adjusting the volume level of each of the music pieces in the low-frequency band can be facilitated.

[5] In the acoustic control device according to any one of claims [1] to [4], when the operator reaches an end of the operable range of the operator, an entire volume of the first music piece is set at a minimum volume.

According to the above arrangement, the second music piece can be solely outputted by moving the fader operator to the end. Accordingly, in addition to being capable of switching from the first music piece to the second music piece, the position for switching the first music piece and the second music piece can be easily recognized by a user.

[6] In the acoustic control device according to any one of claims [1] to [5], the volume level of the first music piece in the low-frequency band is lowered when the operator is operated in a first direction, and
the volume level of the first music piece in each of a high-frequency band and a medium-frequency band is lowered when the operator is further operated in the first direction from a position at which the volume level of the first music piece in the low-frequency band is at a minimum level.

According to the above arrangement, when the fader operator is operated in the first direction, the volume level of the first music piece in each of the high-frequency band and the medium-frequency band is lowered after the volume level of the first music piece in the low-frequency band is lowered to the minimum level. Accordingly, when the first music piece is to be switched to the second music piece, since the volume of the first music piece in each of the high-frequency and the medium-frequency bands is lowered after the volume of the first music piece in the low-frequency band is switched to the volume of the second music piece in the low-frequency band, the first music piece can be switched to the second music piece without arousing uncomfortable impression.

[7] In the acoustic control device according to any one of claims [1] to [6], the operator is a cross fader having a slidable fader operator.

According to the above arrangement, the first and second music pieces can be mixed by operating the fader operator without arousing uncomfortable impression. Accordingly, as compared with an instance where an operator for controlling the volume of the first music piece and an an operator for controlling the volume of the second music piece are to be operated, the first and second music pieces can be more easily mixed.

[8] In the acoustic control device according to [7],
a direction oriented from a first end to a second end of an operable range of the fader operator is a first operation direction, the operable range including:
a first section between a first position and a second position located in the first operation direction with respect to the first position;
a second section between the second position and a third position located in the first operation direction with respect to the second position; and
a third section between the third position and a fourth position located in the first operation direction with respect to the third position;
when the fader operator is positioned within the first section, the volume level of the second music piece in each of a high-frequency band and a medium-frequency band is raised in accordance with an operation of the fader operator in the first operation direction while the volume level of the first music piece in each of a high-frequency band, a medium-frequency band, and the low-frequency band is at a preset maximum level and the volume level of the second music piece in the low-frequency band is at a minimum level,
when the fader operator is positioned within the second section, the volume level of the first music piece in the low-frequency band is lowered and the volume level of the second music piece in the low-frequency band is raised in accordance with the operation of the fader operator in the first operation direction while the volume level of the first music piece in each of the high-frequency band and the medium-frequency band and the volume level of the second music piece in each of the high-frequency band and the medium-frequency band are at the preset maximum level, and
when the fader operator is positioned within the third section, the volume level of the first music piece in each of the high-frequency band and the medium-frequency band is lowered in accordance with an operation of the fader operator in the first operation direction while the volume level of the second music piece in each of the high-frequency band, the medium-frequency band, and the low-frequency band is at the preset maximum level and the volume level of the first music piece in the low-frequency band is at the minimum level.

According to the above arrangement, when the fader operator is moved from the first end to the second end, after the volumes of the second music piece in the high-frequency band and the medium-frequency band are raised and the volume of the second music piece in the low-frequency band is switched to the volume of the first music piece in the low-frequency band, the volume of the first music piece in each of the high-frequency band and the medium-frequency band is lowered.

Accordingly, the first music piece can be switched to the second music piece without arousing uncomfortable impression.

[9] In the acoustic control device according to [8],
the first position is the first end,
the fourth position is the second end,
the first section is a section defined by one third of the operable range from the first end,
the second section is a section defined by one third of the operable range from the second position, and
the third section is a section defined by one third of the operable range from the third position.

According to the above arrangement, the first section for the volume of the second music piece in each of the high-frequency band and the medium-frequency band to be adjusted, the second section for each of the first and second music pieces in the low-frequency band to be adjusted, and the third section for the first music piece in the high-frequency band and the medium-frequency band to be adjusted can be intuitively recognized by a user. In other words, the range for adjusting the volume of each of the frequency bands of the music pieces can be intuitively recognized by a user. Accordingly, an operation of the fader operator in mixing the first and second music pieces can be facilitated.

[10] In the acoustic control device according to any one of claims [1] to [9], when BPM of the first music piece are different from BPM of the second music piece,
playback BPM of the second music piece are set at the BPM of the first music piece when the volume of the first music piece is the preset maximum value and the volume of the second music piece is a minimum value, and
the playback BPM of the second music piece are brought close to the BPM of the second music piece in accordance with an operation of the operator in a direction for lowering the volume of the first music piece and for raising the volume of the second music piece.

According to the above arrangement, as the ratio of the volume of the second music piece in the volume outputted by the acoustic control device becomes larger than the ratio of the volume of the first music piece, the playback BPM of the second music piece approach the BPM of the second music piece from the BPM of the first music piece. Accordingly, the playback BPM of the music pieces can be equalized in accordance with the volume balance between the first and second music pieces. In other words, since the music pieces are played at the BPM close to the BPM of one of the music pieces whose volume ratio in the outputted volume is larger, uncomfortable impression aroused when the first and second music pieces with large difference in BPM are mixed can be reduced. Accordingly, the first music piece can be switched to the second music piece without arousing uncomfortable impression.

[11] In the acoustic control device according to [10],
the playback BPM of the second music piece and the BPM of the second music piece are equalized when the volume of the first music piece is at a minimum value and the volume of the second music piece is at the preset maximum value within the operable range of the operator.

According to the above arrangement, the playback BPM of the second music piece become the BPM set for the second music piece at the timing when the process for switching the first music piece to the second music piece is completed. Accordingly, the second music piece can be played at the BPM set for the second music piece.

[12] An acoustic control program is recorded in a manner readable by a computer, the acoustic control program causing the computer to function as the acoustic control device according to any one of [1] to [11].

The acoustic control program, which is executed by the computer, can achieve the same advantages as those of the above-described acoustic control device.

### EXPLANATION OF CODES

1 . . . acoustic control device, 33A . . . first channel fader, 33A1 . . . first operator (operator), 336 . . . second channel fader, 33B1 . . . second operator (operator), 5 . . . cross fader, 51 . . . fader operator, 6, 6A . . . controller, 61, 61A . . . first playback unit, 62, 62A . . . second playback unit, 63 . . . position acquisition unit, 64 . . . mode switching unit, 65 . . . volume adjuster, 66 . . . BPM setting unit, 67 . . . operation determining unit, 68 . . . playback control unit, 69 . . . position setting unit, 70 . . . position selecting unit, PA1 . . . position, PB1 . . . position, PC1 . . . first position, PC2 . . . second position, PC3 . . . third position, PC4 . . . fourth position, RA, RB, RC . . . operable range, RA1, RB1, RC1 . . . first section, RA2, RB2, RC2 . . . second section, RC3 . . . third section, TC1 . . . first end, TC2 . . . second end

1. An acoustic control device configured to mix a first music piece and a second music piece, wherein
in accordance with an operation of an operator configured to adjust a volume of the first music piece and a volume of the second music piece,
a volume of the first music piece in a low-frequency band and a volume of the second music piece in a low-frequency band are switched by lowering a volume level of the first music piece in the low-frequency band and raising a volume level of the second music piece in the low-frequency band.

2. The acoustic control device according to claim 1, wherein
while the volume level of the first music piece in the low-frequency band is lowered and the volume level of the second music piece in the low-frequency band is raised, a volume level of the first music piece in each of a high-frequency band and a medium-frequency band and a volume level of the second music piece in each of a high-frequency band and a medium-frequency band are kept.

3. The acoustic control device according to claim 1, wherein
the volume of the first music piece in the low-frequency band and the volume of the second music piece in the low-frequency band are switched while a volume level of the first music piece in each of a high-frequency band and a medium-frequency band and a volume level of the second music piece in each of a high-frequency band and a medium-frequency band are at a preset maximum level.

4. The acoustic control device according to claim 1, wherein
when the operator reaches a middle position of an operable range of the operator, the volume level of the first music piece in the low-frequency band and the volume level of the second music piece in the low-frequency band are equalized.

5. The acoustic control device according to claim 1, wherein
when the operator reaches an end of the operable range of the operator, an entire volume of the first music piece is set at a minimum volume.

6. The acoustic control device according to claim 1, wherein
the volume level of the first music piece in the low-frequency band is lowered when the operator is operated in a first direction, and
the volume level of the first music piece in each of a high-frequency band and a medium-frequency band is lowered when the operator is further operated in the first direction from a position at which the volume level of the first music piece in the low-frequency band is at a minimum level.

7. The acoustic control device according to claim 1, wherein
the operator is a cross fader having a slidable fader operator.

8. The acoustic control device according to claim 7, wherein
a direction oriented from a first end to a second end of an operable range of the fader operator is a first operation direction, the operable range including:
a first section between a first position and a second position located in the first operation direction with respect to the first position;
a second section between the second position and a third position located in the first operation direction with respect to the second position; and
a third section between the third position and a fourth position located in the first operation direction with respect to the third position,
when the fader operator is positioned within the first section, the volume level of the second music piece in each of a high-frequency band and a medium-frequency band is raised in accordance with an operation of the fader operator in the first operation direction while the volume level of the first music piece in each of a high-frequency band, a medium-frequency band, and the low-frequency band is at a preset maximum level and the volume level of the second music piece in the low-frequency band is at a minimum level,
when the fader operator is positioned within the second section, the volume level of the first music piece in the low-frequency band is lowered and the volume level of the second music piece in the low-frequency band is raised in accordance with the operation of the fader operator in the first operation direction while the volume level of the first music piece in each of the high-frequency band and the medium-frequency band and the volume level of the second music piece in each of the high-frequency band and the medium-frequency band are at the preset maximum level, and
when the fader operator is positioned within the third section, the volume level of the first music piece in each of the high-frequency band and the medium-frequency band is lowered in accordance with an operation of the fader operator in the first operation direction while the volume level of the second music piece in each of the high-frequency band, the medium-frequency band, and the low-frequency band is at the preset maximum level and the volume level of the first music piece in the low-frequency band is at the minimum level.

9. The acoustic control device according to claim 8, wherein
the first position is the first end,
the fourth position is the second end,
the first section is a section defined by one third of the operable range from the first end,
the second section is a section defined by one third of the operable range from the second position, and
the third section is a section defined by one third of the operable range from the third position.

10. The acoustic control device according to claim 1, wherein
when BPM of the first music piece are different from BPM of the second music piece,
playback BPM of the second music piece are set at the BPM of the first music piece when the volume of the first music piece is the preset maximum value and the volume of the second music piece is a minimum value, and
the playback BPM of the second music piece are brought close to the BPM of the second music piece in accordance with an operation of the operator in a direction for lowering the volume of the first music piece and for raising the volume of the second music piece.

11. The acoustic control device according to claim 10, wherein
the playback BPM of the second music piece and the BPM of the second music piece are equalized when the volume of the first music piece is at a minimum value and the volume of the second music piece is at the preset maximum value within the operable range of the operator.

12. A non-transitory computer-readable storage medium storing an acoustic control program causing a computer to function as the acoustic control device according to claim 1.

13. The acoustic control device according to claim 1, wherein a magnitude relationship only between the volume of the first music piece in the low-frequency band and the volume of the second music piece in the low-frequency band is switched.
